(19) United States
(12) Patent Application Publication
(10) Pub. No.: US 2004/0015730 A1
(43) Pub. Date: Jan. 22, 2004

(54) Contents delivery system, and device, method, recording media, or program for the same

(75) Inventors: Yuko Arai, Tokyo (JP); Mitsuhiro Kageyama, Tokyo (JP); Ryota Tsukidate, Kawasaki-shi (JP); Hirohito Kitatora, Osaka-shi (JP)

Correspondence Address: BROWDY AND NEIMARK, P.L.L.C., 624 NINTH STREET, NW, SUITE 300, WASHINGTON, DC, 20001-5303, US

(73) Assignee: Matsushita Electric Industrial Co., Ltd., Osaka (JP)

(21) Appl. No.: 10/452,927

(22) Filed: Jun. 3, 2003

(30) Foreign Application Priority Data
Jun. 3, 2002 (JP) P2002-161194

(51) Int. Cl. H04L 9/00; H04K 1/00; G06F 15/173

(52) U.S. Cl. 713/201; 709/223; 705/51; 705/59

(57) ABSTRACT

It is unknown what information terminals and how many information terminals are connected to one contracted information terminal. Accordingly, contents licensed to use by only family members of one household may be used by other persons. In view of such a situation, it is necessary to create secure environments. The present invention manages subterminals registered in all main terminals in a subterminal management part of a host device, and confirms validity of registration and deregistration by contract-time personal authentication information managed in a main terminal contract management part. Thereby, contents can be delivered only to reliable home networks.

### BACKGROUND OF THE INVENTION

1. Field of the Invention

The present invention relates to a contents delivery system for delivering contents to plural information terminals.

2. Description of the Prior Art

In recent years, with rapid development of the Internet in broadband transmission, video contents delivery services have been started to deliver high volumes of video contents via the Internet. In the contents delivery services, it is very important to set contents use limitations, and some services are proposed which deliver scrambled contents and descramble the scrambled video contents only for use conforming to use contracts. In these video contents delivery services, with plural information terminals connected to one host, a contract must have been made for each of the information terminals to use contracts.

With the development of broadband transmission, an information terminal (STB, etc.) for receiving video contents is attached to each TV from one per household. As a result, plural information terminals exist within a household, and there is a demand to use contents contracted by a specified information terminal within a household in other information terminals as well.

It is very convenient to users that contents contracted by one information terminal can be used in other information terminals as well. However, since it is unknown to contents deliverers what information terminals and how many information terminals are connected to one contracted information terminal, contents licensed to use by only family members of one household may be used by other persons. Such network environments cannot be said to be secure environments. Therefore, it has been necessary to manage connectable information terminals so that only reliable information terminals can use contents. Such environments require collective management of states of contents stored in plural information terminals within households and contents presentation understandable to users. There is a problem that it is difficult to procure contents having been delivered.

From the standpoint of providers to deliver contents, as a service for collecting contractors, there is a demand for simple communication means among households holding contracts with the same service providers.

### SUMMARY OF THE INVENTION

The present invention has been made in view of the above problems, and provides an information terminal management method and a contents delivery system that enables collective management of states of contents stored in plural information terminals within households and contents presentation understandable to users, and simple communications with other households.

To solve the problems, according to the present invention, first, a host device includes: a subterminal management part for managing information about subterminals using contents sent from main terminals; a main terminal contract management part for managing personal information of contractors of the main terminals; and a UI part for specifying main terminals and subterminals to be registered or deregistered, wherein the main terminals include: an authentication part, when registering or deregistering subterminals permitted to use contents sent from the main terminals, for querying the subterminal management part of the host device about whether to permit the registration or deregistration; and an authentication information management part for managing registered subterminals. Thereby, the host device manages subterminals registered in all main terminals and confirms validity of registration and deregistration by contract-time personal authentication information, whereby contents can be delivered only to reliable home networks. The setting of registration limitation conditions prevents malicious users from illegally increasing subterminals. An accounting system dependent on the configuration of subterminals can be built. When contents are delivered, since all contents of formats processable to a main terminal making a request for contents delivery and subterminals registered in the main terminal are sent, format conversion is unnecessary in receiving terminals. Only contents of formats processable to terminals permitted by contents license are delivered, thereby preventing the delivery of meaningless contents not used because of the lack of license.

Second, the host device includes a main terminal list creation part for creating a list of main terminals or subterminals, and the main terminals or subterminals further include a UI part for enabling specification of other main terminals or subterminals registered in the main terminals as communication parties, and an inter-terminal communication part for communicating with other terminals. This realizes simple communication means among households holding contracts with the same service providers and makes it possible for service providers delivering contents to provide services for collecting contractors.

Third, the subterminals include: a contents storage part for storing contents sent from the main terminals; and a takeout determination part for determining whether the subterminals can be taken out, and the main terminals include: a contents storage part for storing contents sent from the host terminal; and a contents storage information management part for managing contents storage information, whereby storage states in plural contents storage parts within a home network are collectively managed, and takeout limitations and reservations for the contents are enabled. Thereby, the states of storage devices of plural terminals within the home network can be shown in a form easily understandable to users because the storage devices appear to be one storage device.

Fourth, the host device includes: a contents list management part for managing contents lists showing the correspondence between the main terminals and contents successfully stored by the individual main terminals, and sending the contents lists to the main terminals; a contents delivery history management part for collecting and managing contents delivery histories; and a delivery charge computation part for computing amounts to be paid to the users of the main terminals according to the contents delivery histories, wherein the main terminals include: a data receiving part for receiving a contents list sent from the contents list management part; an inter-terminal communication part for receiving contents sent from other main terminals; a UI part for showing a contents list to receive selection of contents; a contents storage part for storing contents; and a contents delivery history creation part for creating contents delivery histories containing information about main terminals to deliver contents from and sending the contents delivery histories to the host device, whereby contents lists are provided to the subterminals, and contents delivery from other home networks is enabled. Thereby, even contents having been delivered from the host device can be provided to users. Also, by compiling contents delivery histories and enabling charge computations according to the delivery histories, a business is established in which service providers managing contents and licenses and performing contents delivery pay charges for contents delivery operations to contractors of main terminals having performed contents delivery in place of the host device.

As has been described above, according to the present invention, the host device manages subterminals registered in all main terminals and confirms validity of registration and deregistration by contract-time personal authentication information, whereby contents can be delivered only to reliable home networks. The setting of registration limitation conditions prevents malicious users from illegally increasing subterminals. An accounting system dependent on the configuration of subterminals can be built.

When contents are delivered, since all contents of formats processable to a main terminal making a request for contents delivery and subterminals registered in the main terminal are sent, format conversion is unnecessary in receiving terminals.

Only contents of formats processable to terminals permitted by contents license are delivered, thereby preventing the delivery of meaningless contents not used because of the lack of license.

By realizing simple communication means among households holding contracts with the same service providers, providers to deliver contents can provide services for collecting contractors.

Storage states in plural contents storage parts within a home network are collectively managed, and takeout limitations and reservations for the contents are enabled. Thereby, the states of storage devices of plural terminals within the home network can be shown in a form easily understandable to users because the storage devices appear to be one storage device.

Contents lists are provided to the subterminals, and contents delivery from other home networks is enabled. Thereby, even contents having been delivered from the host device can be provided to users. Also, by compiling contents delivery histories and enabling charge computations according to the delivery histories, a business is established in which service providers managing contents and licenses and performing contents delivery pay charges for contents delivery operations to contractors of main terminals having performed contents delivery in place of the host device.

Objects and advantages of the present invention as described above will be made more apparent from embodiments described below with reference to the accompanying drawings.

### BRIEF DESCRIPTION OF THE DRAWINGS

FIG. 1 is a diagram showing a contents delivery system in a first embodiment of the present invention;

FIG. 2 is a diagram showing a main terminal contract management table in the first embodiment;

FIG. 3 is a diagram showing a subterminal management table in the first embodiment;

FIG. 4 is a diagram showing a contents use status management table in the first embodiment;

FIG. 5 is a diagram showing a contents license management table in the first embodiment;

FIG. 6 is a diagram showing a contents management table in the first embodiment;

FIG. 7 is a flowchart explaining a contents acquisition processing in the first embodiment;

FIG. 8 is a diagram showing a contents use status management table in the first embodiment;

FIG. 9 is a flowchart explaining a download processing of contents in a first embodiment;

FIG. 10 is a flowchart explaining a registration processing of a subterminal to a main terminal in the first embodiment;

FIG. 11 is a diagram showing a subterminal management table in the first embodiment;

FIG. 12 is a diagram showing a subterminal management table in the first embodiment;

FIG. 13 is a diagram showing a main terminal management table in the first embodiment;

FIG. 14 is a flowchart showing processing for using contents of a main terminal in a subterminal in the first embodiment;

FIG. 15 is a flowchart explaining contents use check processing in the first embodiment;

FIG. 16 is a flowchart explaining processing for deregistering main terminals and subterminals from a host device in the first embodiment;

FIG. 17 is a diagram showing a contents delivery system in a second embodiment of the present invention;

FIG. 18 is a diagram showing a main terminal list in the second embodiment;

FIG. 19 is a flowchart explaining processing of inter-terminal communication in the second embodiment;

FIG. 20 is a diagram showing a subterminal management table in the second embodiment;

FIG. 21 is a diagram showing conditions specific to terminals used in the second embodiment;

FIG. 22 is diagram showing alternative search conditions in the second embodiment;

FIG. 23 is a diagram showing a contents delivery system in a third embodiment of the present invention;

FIG. 24 is a diagram showing contents storage information in the third embodiment;

FIG. 25 is a diagram showing contents storage location decision conditions in the third embodiment;

FIG. 26 is a flowchart explaining storage processing for delivered contents in the third embodiment;

FIG. 27 is a diagram showing a presentation example in a UI part in the third embodiment;

FIG. 28 is a diagram showing takeout determination criteria standard in the third embodiment;

FIG. 29 is a diagram showing a contents delivery system in a fourth embodiment of the present invention;

FIG. 30 is a diagram showing a contents list in the fourth embodiment;

FIG. 31 is a diagram showing a contents list in the fourth embodiment;

FIG. 32 is a diagram showing terminal selection conditions in the fourth embodiment;

FIG. 33 is a diagram showing a contents delivery system in the fourth embodiment;

FIG. 34 is a diagram showing contents list sending information in the fourth embodiment;

FIG. 35 is a diagram showing circulation of contents lists in the fourth embodiment;

FIG. 36 is a diagram showing a contents delivery history in the fourth embodiment;

FIG. 37 is a diagram showing a contents list delivery history compilation table in the fourth embodiment; and

FIG. 38 is a diagram showing a charge calculation result table in the fourth embodiment.

### DESCRIPTION OF THE PREFERRED EMBODIMENTS

Hereinafter, a contents delivery system according to embodiments of the present invention will be described with reference to the drawings.

(First Embodiment)

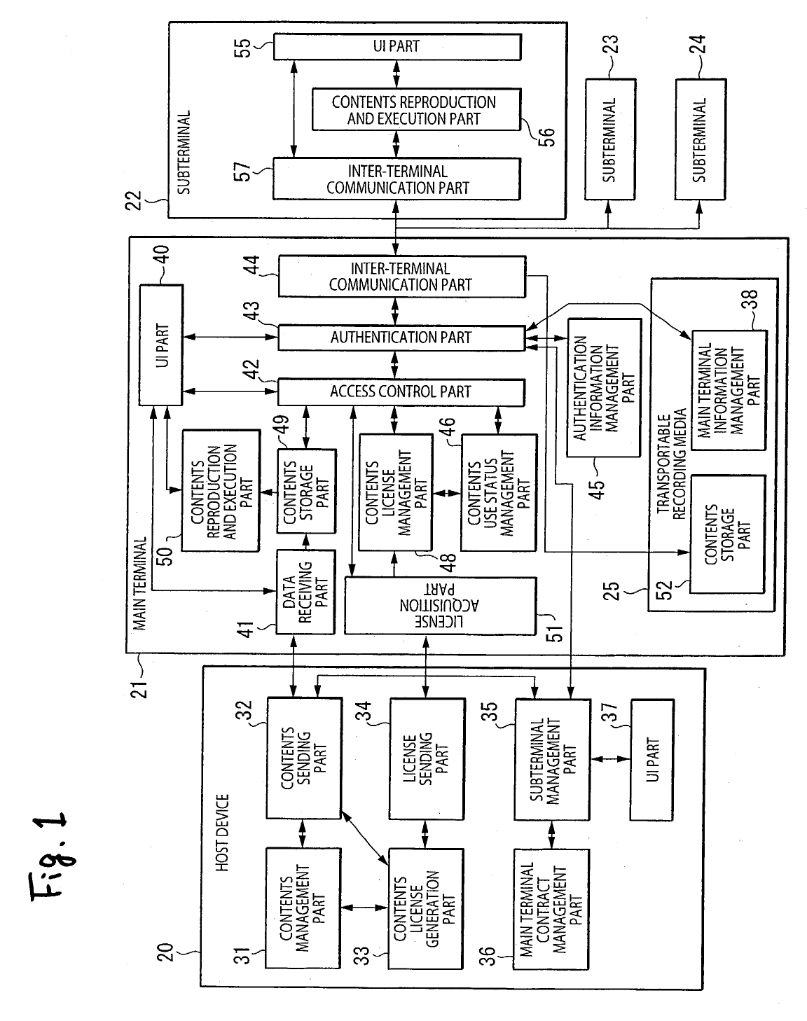

As shown in FIG. 1, the contents delivery system has a host device 20 and plural information terminals, and delivers contents of the host device 20 to the information terminals through transmission lines (communication lines or data broadcasting). The information terminals fall into two categories: a main terminal 21 and subterminals 22, 23, and 24, which are managed as to their contents use state by the main terminal 21. The number of subterminals is unlimited. Also, the number of main terminals is unlimited. Hereinafter, in this specification, a network which comprises one main terminal and subterminals connected thereto will be referred to as a home network.

The host device comprises a contents management part 31, a contents sending part 32, a contents license generation part 33, a license sending part 34, a subterminal management part 35, a main terminal contract management part 36, and a UI (user interface) part 37, and sends contents to the information terminals. Upon receipt of a request to use contents from the information terminals, the host device sends contents license to the information terminals.

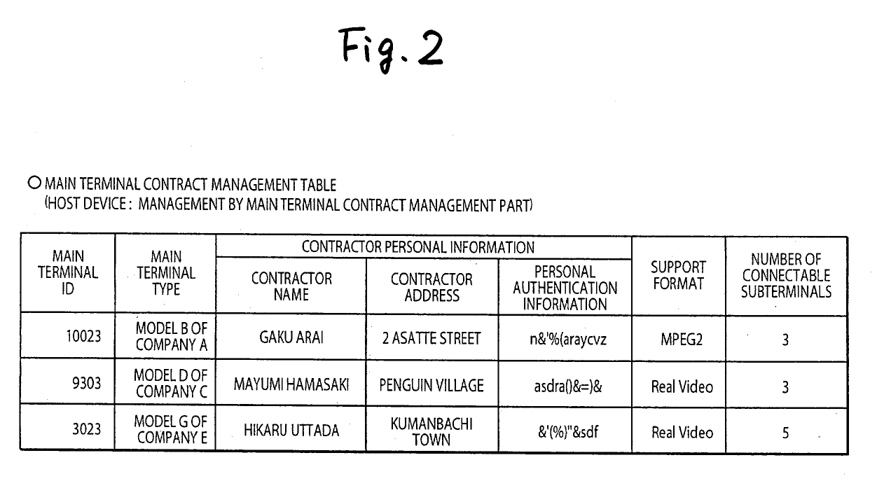

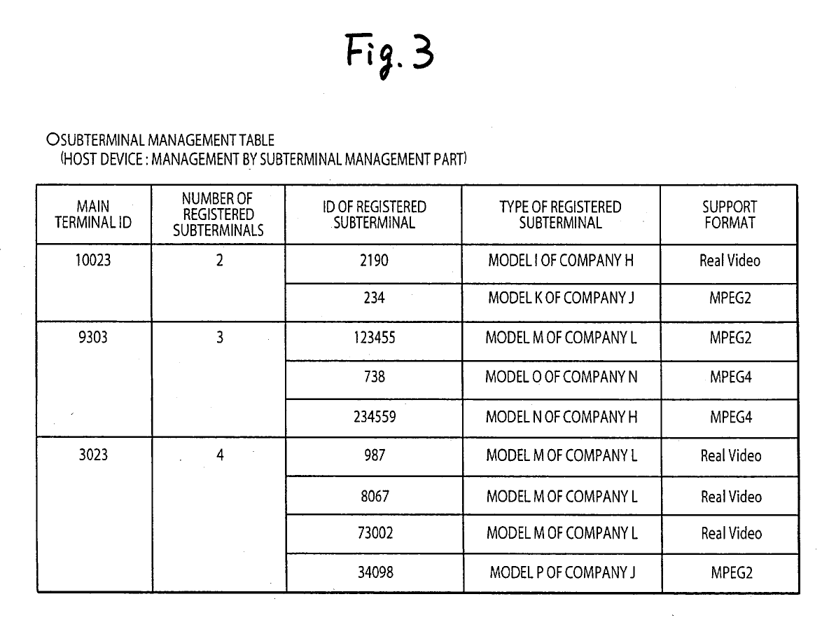

The contents management part 31 holds plural contents such as video contents, music contents, and games, and a contents management table in which contents names, contents details, and the like are managed by contents ID. The contents license generation part 33 has a contents license management table corresponding to the contents management table, and generates contents licenses from the contents license management table, in response to a request from the main terminal 21. The contents sending part 32 and the license sending part 34 respectively send contents, and the contents management table and licenses to the information terminals. The main terminal contract management part 36 manages contents, the contents management table, personal information of contractors to receive licenses, and main terminal information which are sent from the host device 20. Specifically, for example, as shown in FIG. 2, these items of information are managed by a main terminal contract management table consisting of contractor personal information containing main terminal ID, main terminal type, and authentication information, support format, the number of connectable subterminals, and the like. The subterminal management part 35 manages subterminals registered as terminals using contents received by the main terminal. Specifically, for example, as shown in FIG. 3, the subterminals are managed by a subterminal management table consisting of main terminal ID, the number of registered subterminals, registered subterminal ID, registered subterminal type, registered subterminal support format, and the like. The UI part 37 specifies subterminals to be registered or deregistered.

The main terminal 21 will be described. The main terminal 21 includes a UI part 40, a data receiving part 41, an access control part 42, an authentication part 43, an inter-terminal communication part 44, an authentication information management part 45, a contents use status management part 46, a contents license management part 48, a contents storage part 49, a contents reproduction and execution part 50, a license acquisition part 51, and a transportable recording medium 25. The UI part 40 is connected with a TV and a remote controller used by a user to issue requests to the main terminal 21. The authentication part 43 determines subterminals connectable to the main terminal 21 in consultation with the authentication information management part 45. The authentication information management part 45 stores the terminal IDs of subterminals authorized to connect to the main terminal 21.

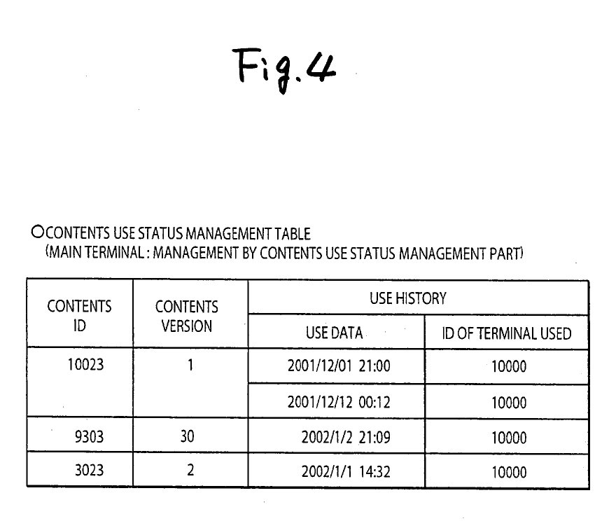

The contents use status management part 46 manages the use statuses of individual contents in the information terminals. Specifically, the use statuses of the contents are managed by a contents use status management table shown in FIG. 4. Use date, use terminal, and the like are recorded and managed for each of the contents versions of contents IDs.

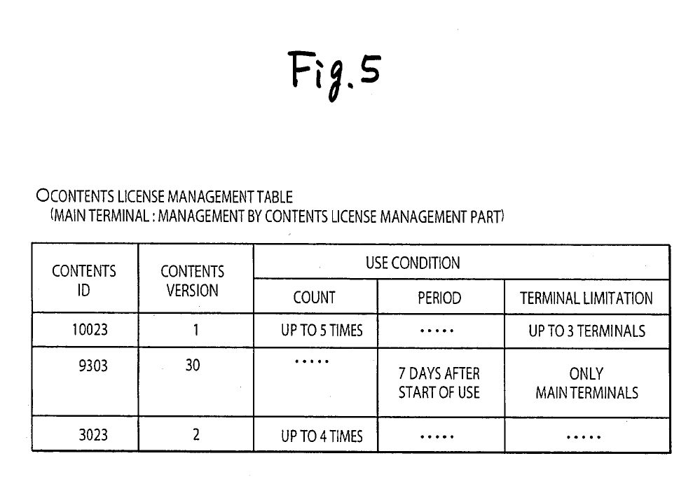

The contents license management part 48 manages contents licenses including use conditions for contents provided from the contents license generation part 33. Specifically, contents are managed by a contents license management table shown in FIG. 5. For example, contents licenses are subjected to use limitation management by contents ID and contents version in terms of use count, use expiration, and use terminal.

The access control part 42 compares contents licenses and contents use statuses described above, and determines whether to reproduce contents.

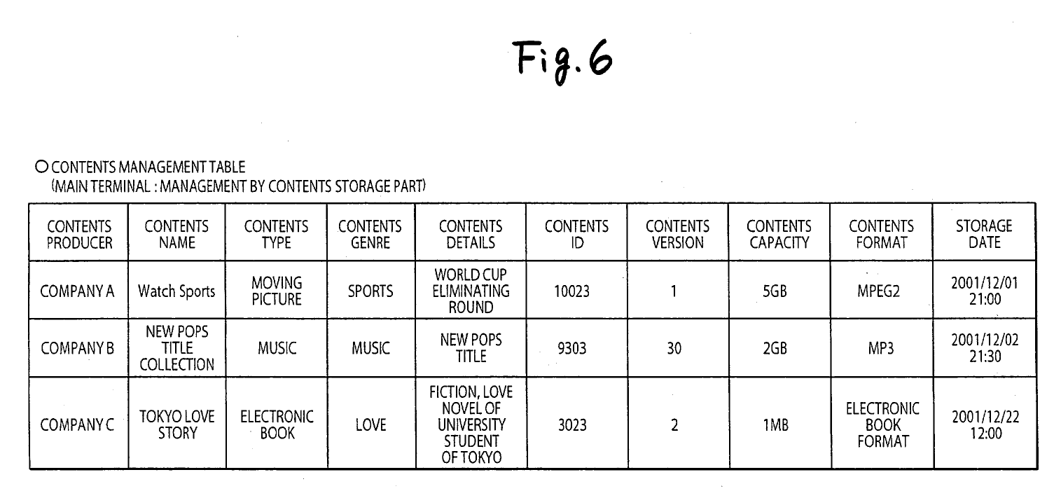

The contents storage part 49 holds contents and a contents management table which were delivered from the host device 20. The contents management table, as shown in FIG. 6, has a contents list containing contents producers, contents names, and the like, and is used for contents selection in the UI part. The contents management table may be described and delivered as contents having a format like normal menus. Alternatively, the contents management table, after being read by applications of terminals, may be displayed through GUI of each of the terminals. The contents storage part 49 is composed of a hard disk over, e.g., 60 gigabytes, e.g., 40 gigabytes of which are allocated to an area called a provider area, which can be updated by only the host device 20. Contents delivered from the host device 20 are stored in the provider area. The contents storage part 49 may be not a hard disk but a memory. The contents reproduction and execution part 50 fetches contents from the contents storage part 49 to reproduce and execute them.

The transportable recording medium 25 includes a contents storage part 52 and a main terminal information management part 38. The contents storage part 52 stores contents delivered from the host device. The main terminal information management part 38 manages main terminal information (e.g., main terminal ID, etc.) for identifying the main terminal in which it is included.

The subterminal 22 will be described. The subterminal 22 includes a UI part 55, a contents reproduction and execution part 56, and an inter-terminal communication part 57. The subterminal 22 receives contents delivered from the main terminal 21 and reproduces the contents in the contents reproduction and execution part 56 of the subterminal 22. The configurations of the subterminals 23 and 24, which are omitted in FIG. 1, are identical with each other.

The contents license management part 48 of the main terminal 21 manages contents licenses of the subterminals 22, 23, and 24, as well as contents licenses of the main terminal 21. Thereby, contents delivered to the main terminal 21 can be shared in the subterminals 22, 23, and 24, as well as in the main terminal 21. In this case, the contents licenses may be defined as “no subterminals are permitted”, “up to three subterminals are permitted”, and the like (see the contents license management table of FIG. 5). In the case where the subterminal 22 attempts to reproduce contents stored in the contents storage part 49, there is no need to access the host device 20, so that the load of access to the host device 20 can be reduced. Contents to be referred to are not limited to contents stored in the main terminal; the licenses can be shared even when contents are directly requested from the subterminals to the host device, or when contents stored in digital media such as DVD are reproduced and executed.

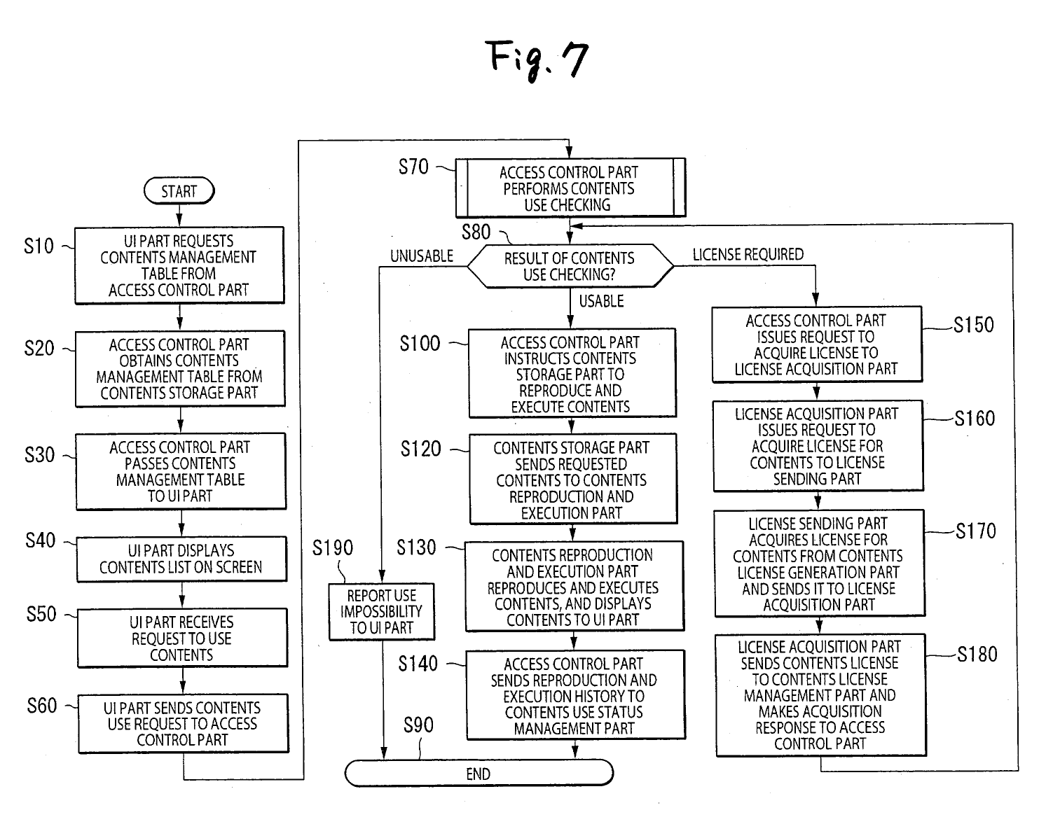

Next, a detailed description will be made of contents acquisition operation of the contents delivery system with reference to a flowchart of FIG. 7.

When contents are to be reproduced in the main terminal 21, the user attempts to display the contents management table on a TV screen. Accordingly, the UI part 40 requests the contents management table from the access control part 42 (S10). The access control part 42 obtains the contents management table from the contents storage part 49 (S20). The access control part 42 passes the contents management table to the UI part 40 (S30), and displays a contents list from the contents management table on a TV screen connected to the UI part 40 (S40).

The user selects contents to be used from the contents management table displayed on the TV screen, and the UI part 40 receives the request to use the contents desired by the user (S50). The UI part 40 sends the contents use request to the access control part 42 (S60), and the access control part 42 performs contents use checking. The contents use checking is a procedure for checking whether a contents license is given to contents requested for use, and whether current use conditions satisfy conditions for using the contents. The contents license management part 48 has a contents license management table (FIG. 5) for managing contents to which contents licenses are given. The contents use status management part 46 has a contents use status management table (see FIG. 4) for managing contents use statuses. Whether the contents can be used is determined by comparing the contents license management table with the contents use status management table. The contents use checking will be described in detail later.

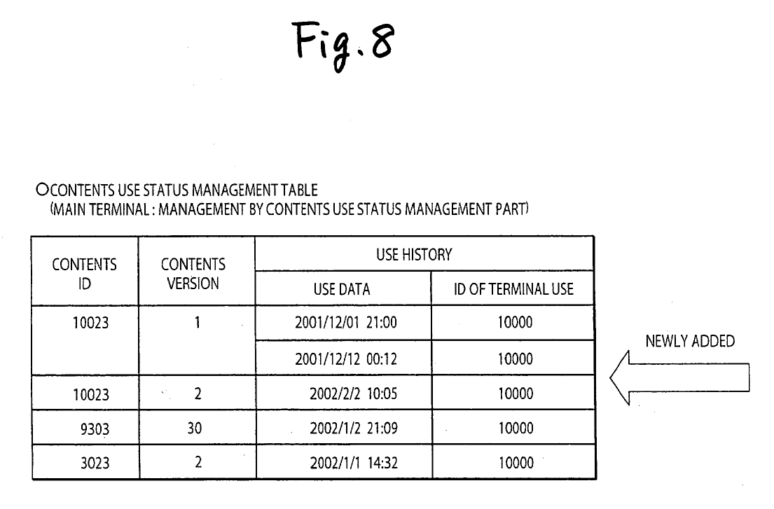

As a result of checking whether the contents can be used (S80), if the use of the contents is permitted, the access control part 42 instructs the contents storage part 49 to reproduce and execute the contents (S100). The contents storage part 49 sends the requested contents to the contents reproduction and execution part 50 (S120). The contents reproduction and execution part 50 reproduces and executes the contents, and displays the contents on a TV screen of the UI part 40 (S130). The access control part 42 sends reproduction and execution history to the contents use status management part 46 and updates the contents use status management table managed in the contents use status management part 46. FIG. 8 shows the contents use status management table when version 2 of contents ID 10023 is used; it will be recognized that a line of use history is added.

As a result of checking whether the contents can be used (S80), if it is found that a license is not given and a license is required to use the contents, the access control part 42 issues a request to acquire a license to the license acquisition part 51 (S150). The license acquisition part 51 issues a request to acquire a license for the contents to the license sending part 34 (S160). The license sending part 34 acquires a license for the contents from the contents license generation part 33 and sends it to the license acquisition part 51 (S170). The license acquisition part 51 sends a contents license to the contents license management part 48 and makes acquisition response to the access control part 42 (S180). After a license to use the contents is set, the contents use checking is performed again (S80) and the contents storage part 49 is instructed to reproduce and execute the contents.

As a result of checking whether the contents can be used (S80), if the contents cannot be used, use impossibility is reported to the UI part 40 (S190) and information indicating use impossibility is displayed on the TV screen, and the processing terminates (S90). However, when use impossibility is reported to the UI part, a license can be acquired again to reproduce the contents. The use impossibility referred to here occurs when although a license to use the contents is once set, the status of using the contents does not satisfy the contents license. An example that a license is not satisfied occurs when access is made from an unauthorized terminal, person, or age. This case is referred to as use impossibility.

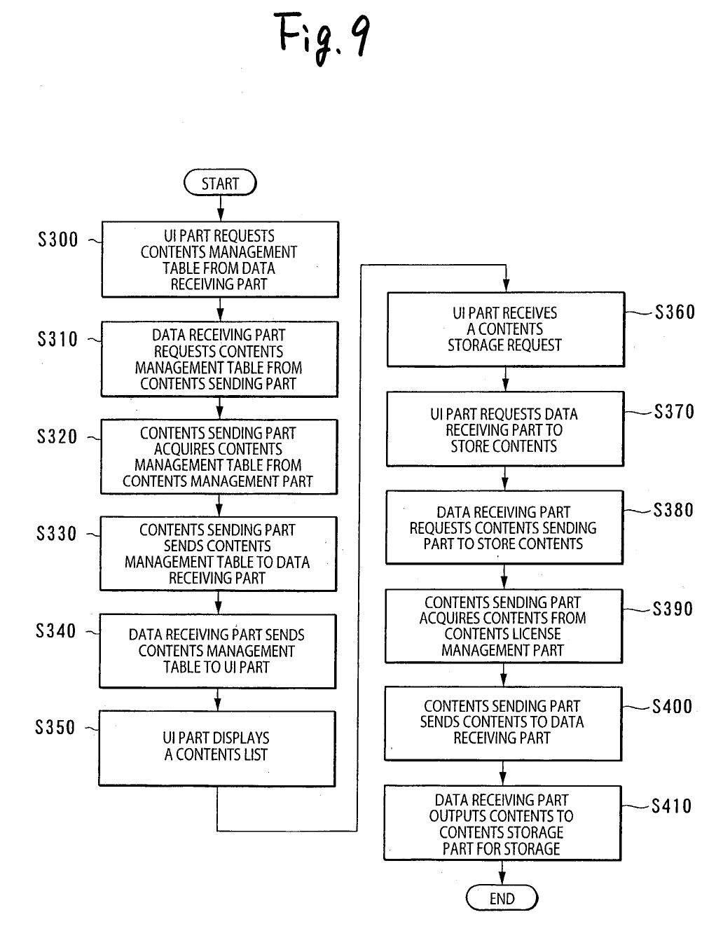

The above processing is performed for the contents management table and requested contents already downloaded into the contents storage part; processing for those not downloaded into the contents storage part will be described using a flowchart of FIG. 9.

The UI part 40 requests the contents management table from the data receiving part 41 (S300), which requests the contents management table from the contents sending part 32 (S310). The contents sending part 32 acquires the contents management table from the contents management part 31 (S320), and sends the contents management table to the data receiving part 41 (S330). The data receiving part 41 sends the contents management table to UI part 40 (S340), which displays a contents list from the contents management table on a TV screen (S350).

From the TV screen, the user selects contents to be used. As a result, the UI part 40 receives a contents storage request (S360) and requests the data receiving part 41 to store the contents in the contents storage part 49 (S370). The data receiving part 41 requests the contents sending part 32 to store the contents (S380), and the contents sending part 32 acquires the contents from the contents management part 31 (S390). The contents sending part 32 sends the contents to the data receiving part 41 (S400), which outputs the contents to the contents storage part 49 for storage (S410). If storage of the contents begins, as described above (S60), a use request is issued to the access control part 42 to check the contents for use. Although an example of storage is shown here, contents may be directly acquired and displayed. Although, in this example, contents are acquired before being checked to see if the contents can be used, the contents may be acquired after being checked to see if the contents can be used and determined to be usable.

The above description is made of the case where contents are used in only the main terminal 21. Next, a description will be made of the case where contents are used in the subterminals 22 connected to the main terminal 21.

Before using contents of the main terminal 21, the subterminal 22 must be registered in the main terminal 21. The main terminal 21 beforehand makes a contract for receiving contents delivered from the host device 20, and the contract contents are managed by a main terminal contract management table as shown in FIG. 2 in the main terminal contract management part 36.

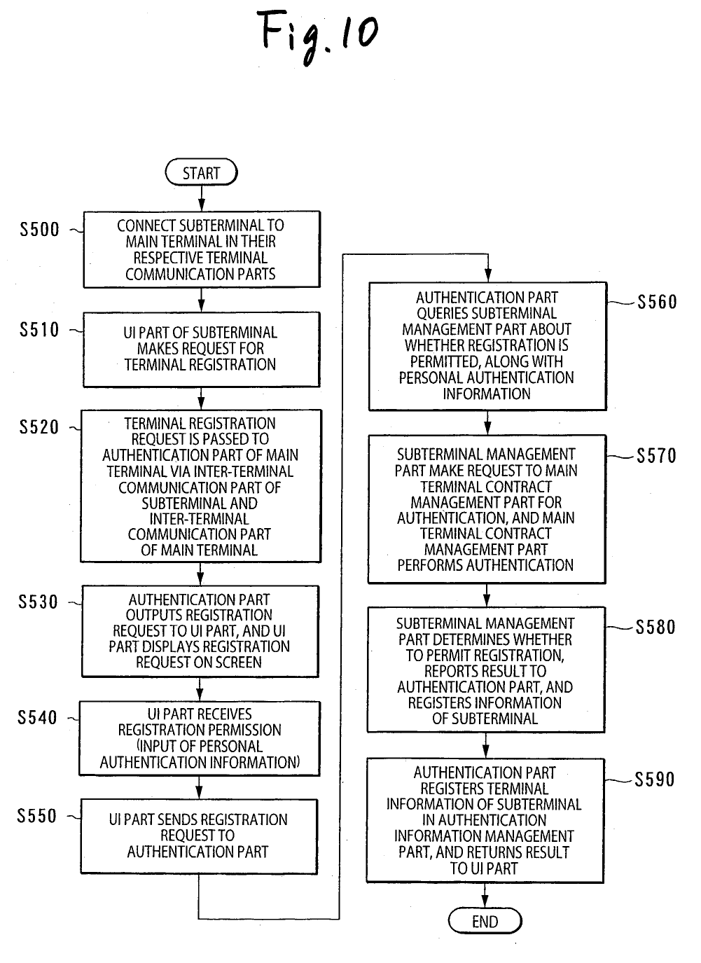

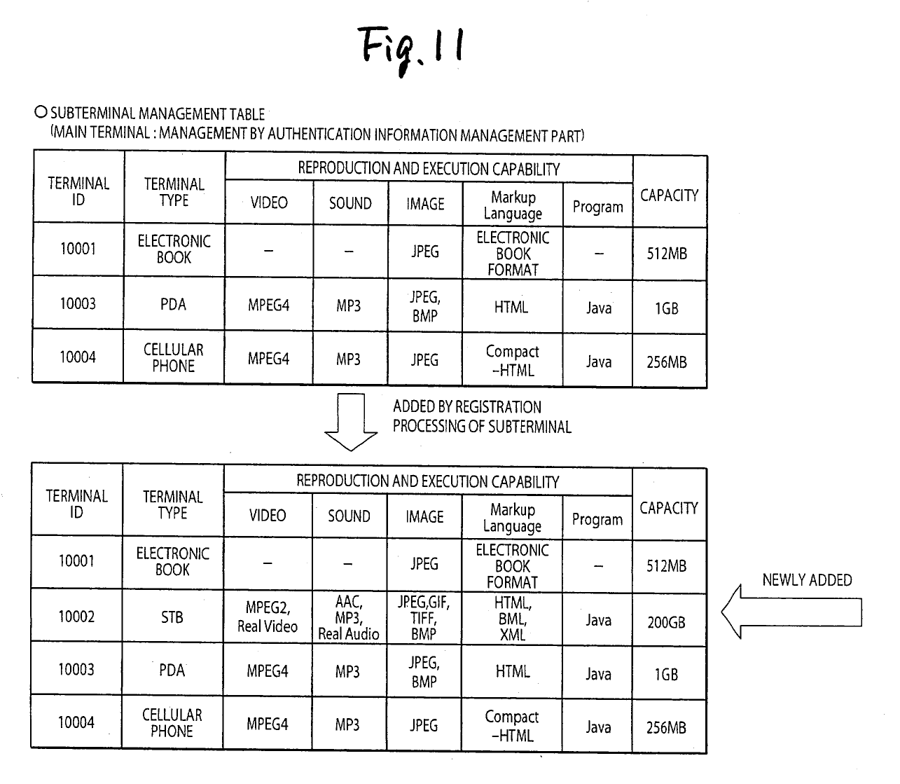

To register the subterminal 22 in the main terminal 21, as shown by a flowchart of FIG. 10, the subterminal 22 is connected to the main terminal 21 in their respective terminal communication parts (S500). They may be connected through a wire or wirelessly. The UI part 55 of the subterminal 22 makes a request to the main terminal 44 for terminal registration (S510). The terminal registration request is passed to the authentication part 43 of the main terminal via the inter-terminal communication part 57 of the subterminal 22 and the inter-terminal communication part 44 of the main terminal (S520). The authentication part 43 outputs a registration request to the UI part 55, and the UI part 40 displays the registration request on a TV screen (S530). If the subterminal 22 may be registered in the main terminal 21, the user of the main terminal registers the subterminal by use of an input means such as a remote control. The user of the main terminal inputs personal authentication information such as password and fingerprint information registered at the time of the contract (S540). The UI part 40 receives registration permission and sends a registration request to the authentication part 43 (S550). The authentication part 43 queries the subterminal management part 35 of the host device 20 about whether registration is permitted (S560), along with a main terminal ID, personal authentication information, and the like. The subterminal management part 35 uses the main terminal ID, personal authentication information, the subterminal ID of a subterminal to be registered, and the like to make a request to the main terminal contract management part 36 for authentication, and the main terminal contract management part 36 performs authentication from the sent personal authentication information and main terminal contract management information (S570). For example, if a registration request is sent from a main terminal with a main terminal ID of 10023, a check is made to see if sent personal authentication information matches personal authentication information of the main terminal ID 10023 registered in the main terminal management table. If they do not match, registration rejection is returned to the authentication part 43 through the subterminal management part 35. If they match, the main terminal contract management part 36 returns authentication permission to the subterminal management part 35 along with the number of connectable subterminals, and the subterminal management part 35 determines whether the registration results in the number of connectable subterminals exceeding a limited value. For example, since the main terminal contract management table as shown in FIG. 2 shows that a main terminal with a main terminal ID of 10023 can register three subterminals, and the subterminal management table as shown in FIG. 3 shows that the number of registered subterminals is two, one more subterminal can be registered. On the other hand, in a main terminal with a main terminal ID of 9303, three subterminals, which is the number of connectable subterminals, have already been registered. Therefore, no more subterminals can be registered. If the number of connectable subterminals is not exceeded, registration permission is returned to the authentication part 43, and the subterminal management part 35 registers terminal information (registration subterminal ID, registration subterminal type, registration subterminal support format, etc.) of the subterminal requested for registration (S580). Upon receipt of the authentication permission, the authentication part 43 registers terminal information of the subterminal 22 in the authentication information management part 45, and returns a result to the UI part 40 (S590). Subterminals registered as connectable with the main terminal 21, managed in the authentication information management part 45, are managed by the subterminal management table as shown in FIG. 11. The subterminal management table contains terminal IDs permitted for connection, terminal type, reproduction capabilities, recording capacity, and the like. Newly adding terminal IDs increases items of the subterminal management table.

By executing such a procedure, the main terminal 21 and the subterminal 22 form a home network which allows contents stored in the contents storage part 49 to be shared in the subterminal 22. Sharable contents presuppose that a contents license is given to the subterminal 22. Although, in the above-described procedure, the main terminal 21 and the subterminal were first connected, this is not mandatory, and all information of subterminals may be inputted in the UI part 40 of the main terminal 21.

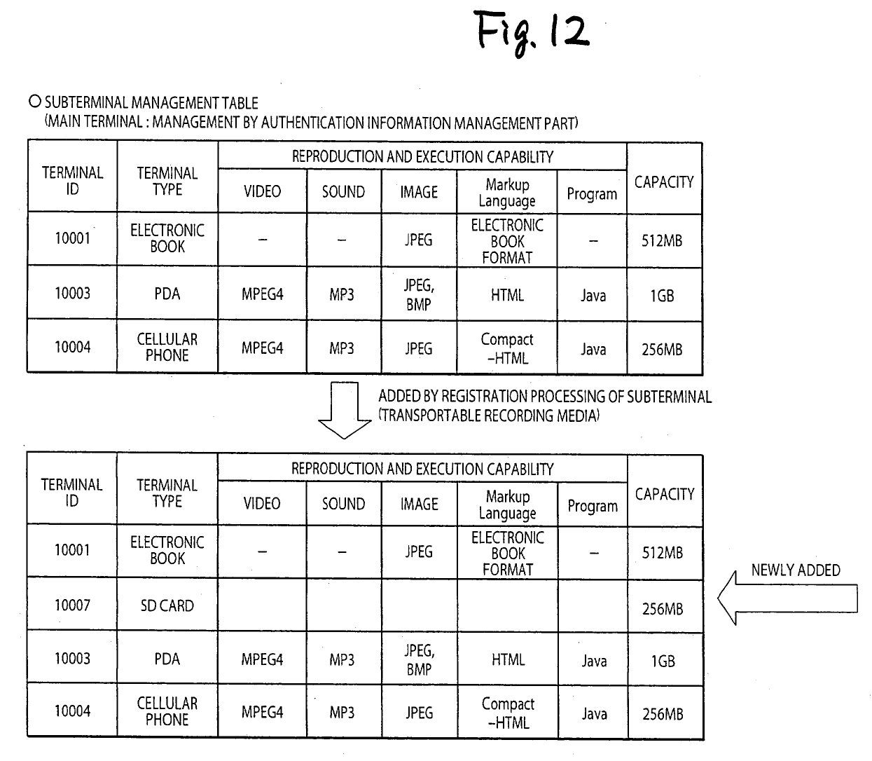

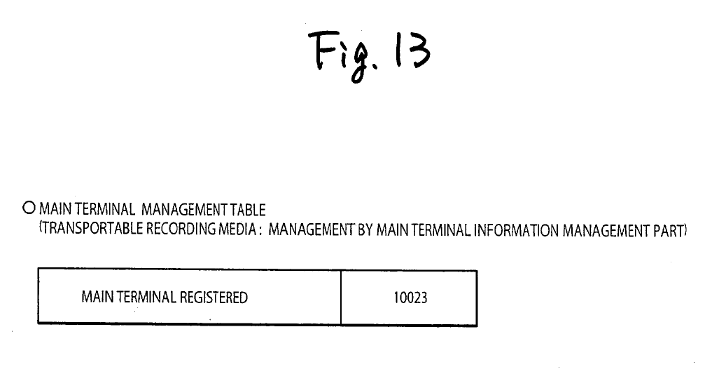

In addition to the subterminal 22, the subterminals 23 and 24 may be registered in the main terminal 21. Not only terminals but also transportable recording media may be registered. In this case, in the above-described procedure, after registration permission is returned to the authentication part 43, and information about the transportable recording medium 25 is registered as shown in FIG. 12 in the subterminal management table of the authentication information management part 45, the main terminal management table managed by the main terminal information management part 38 of the transportable recording medium 25 becomes as shown in FIG. 13. Transportable recording media can be used only in main terminals described in main terminal information and subterminals registered in main terminals, and cannot be used in other terminals.

Although only registration of subterminals is described in the above description, deregistration of subterminals is also performed in the same flow; addition information in the management tables is replaced by deletion processing.

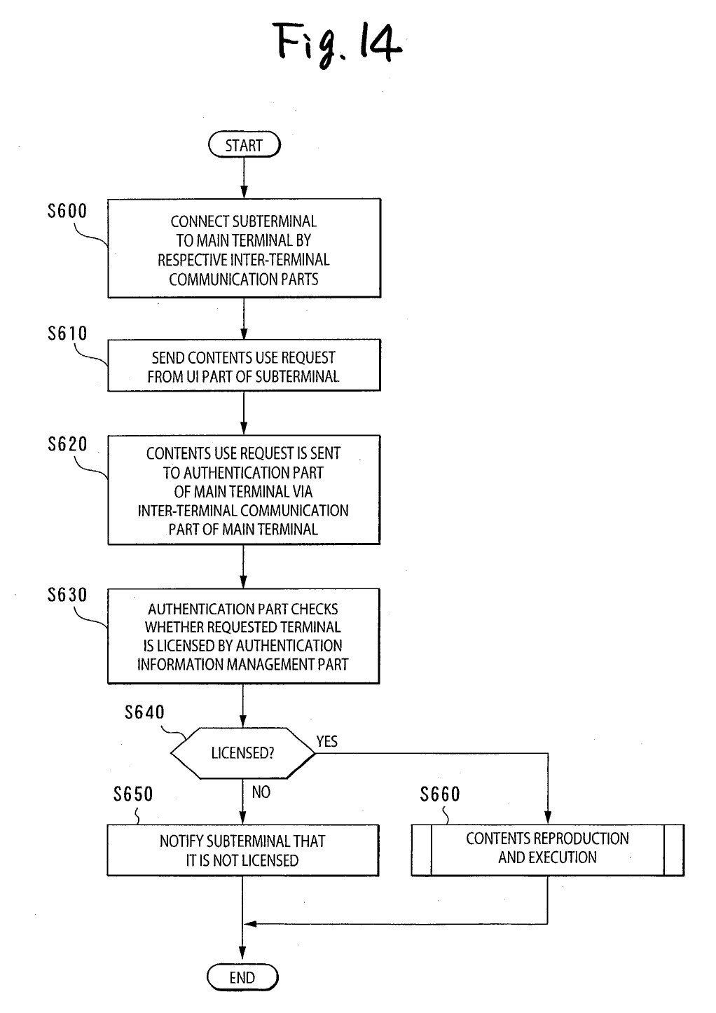

Next, a procedure for using contents in the contents storage part 49 of the main terminal 21 in the subterminal 22 will be described with reference to a flowchart of FIG. 14.

The subterminal 22 is connected to the main terminal 21 by the respective inter-terminal communication parts 44 and 57 (S600). The UI part 55 of the subterminal 22 directs the sending of a contents use request to the main terminal 21 (S610). The contents use request is passed to the authentication part 43 of the main terminal 21 via the inter-terminal communication part 57 of the subterminal 22 and the inter-terminal communication part 44 of the main terminal 21 (S620). The authentication part 43 checks whether the subterminal making a request for use is permitted for use by the authentication information management part 45. As a result, if the subterminal is not permitted for use, the subterminal is notified that it is not permitted for use. Of course, the subterminal cannot use the contents (S650). On the other hand, in the subterminal 22 permitted for use, contents are reproduced and executed (S660). The reproduction and execution procedure is the same as that in the main terminal 21 (S10 to S180), except that the access control part 42 outputs contents not to the contents reproduction and execution part 50 of the main terminal 21 but to the contents reproduction and execution part 56 of the subterminal 22.

If no contents license is set and the contents do not exist in the contents storage part 49 of the main terminal 21, like the main terminal 21, according to a request from the subterminal 22, the purchase of a contents license and contents storage can be made.

In the case where the subterminal 22 directly uses contents of the host device 32, for example, even in the case of the reproduction and execution of normal WWW contents, it is checked whether a license for the contents exists in the main terminal 21, before performing reproduction and execution. Thereby, no matter where contents to be reproduced and executed exist, licenses can be shared.

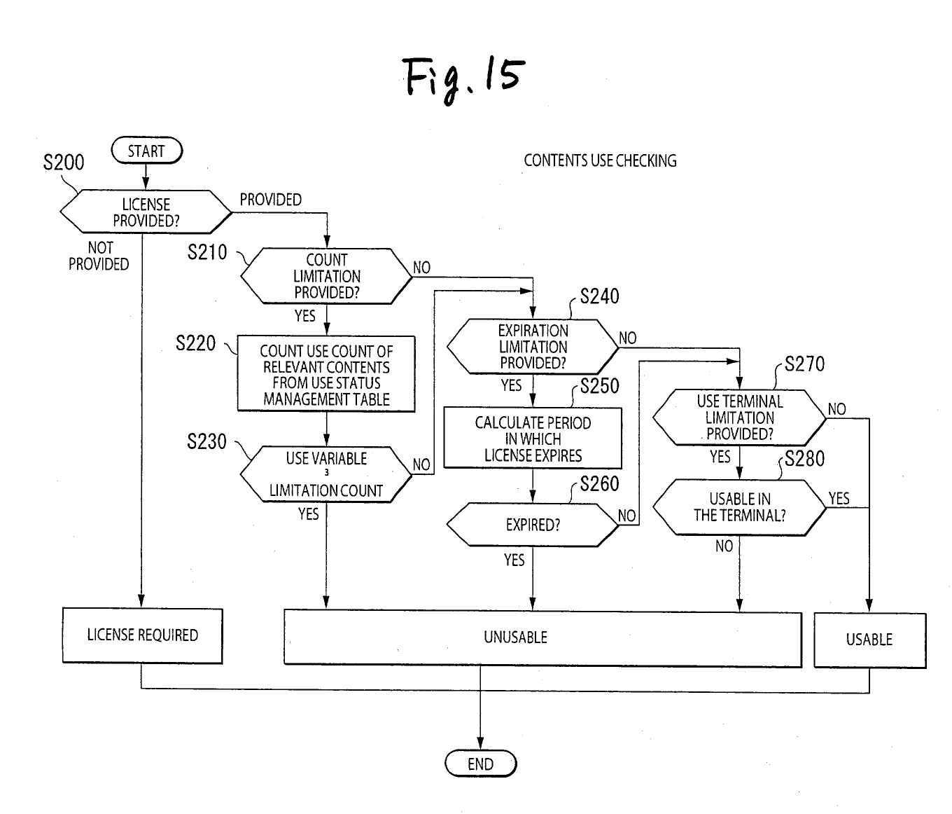

The above-described contents use checking (S80 in the flowchart of FIG. 7) will be described in detail with reference to FIG. 15.

In the contents use checking, it is checked whether a contents license is set for specified contents (S200). Since contents licenses are recorded in the contents license management table (FIG. 5) of the contents license management part 48, the contents management table is checked using the contents ID as key. If the contents ID does not exist in the contents license management table, it is determined that a license is required, and control proceeds to S150 in FIG. 7. If the contents ID exists in the contents license management table, since a license is already set, it is checked whether the license is valid or not.

It is checked whether the license has a count limitation (S210). If there is a count limitation, a use count of the contents is extracted from the use status management table (S220), and it is determined whether a limitation count set in the license exceeds the use count of the contents. If the use count is equal to or greater than the limitation count, the contents are determined to be unusable. A use period has two patterns: a period from a contract date, that is, an absolute date, and a period from a first viewing, that is, a relative date. FIG. 5 shows an example of the latter, a relative date.

Next, if the use count is less than the limitation count, or the license has no count limitation, it is checked whether the license has an expiration limitation (S240). If there is an expiration limitation, a period in which the use period of the contents expires is calculated from the use status management table (S250), and it is checked whether the expiration limitation set in the license violates the use period of the contents (S260). If so, the contents are determined to be unusable.

If the expiration limitation is observed, or the license has no expiration limitation, it is checked whether the license has a limitation on available terminals (S270). If there is a terminal limitation, it is checked whether the contents have a terminal limitation from the use status management table (S280), and it is determined whether use is made in other than terminals to which the license is given. For use in terminals to which the license is not given, the contents are determined to be unusable.

As a result of the above checking, if all the conditions are satisfied, the contents are determined to be usable and control proceeds to S100 of FIG. 7. By performing the contents use checking in this way, various licenses can be set.

Although the above description assumes a configuration in which contents can be shared between the main terminal and subterminals, if the contents use statuses of subsidiary subterminals connected to the subterminals can be managed in the main terminal and the contents licenses of the subsidiary subterminals can also be managed in the main terminal, contents can be shared among the main terminal, subterminals, and subsidiary terminals.

The description is only an example and places no limitations on sequence, conditions, and the like. Licenses may be provided with various limitations such as use limitations for each individual, age, and sex, if an individual to use the system is identified.

As has been described above, if the host device manages subterminals registered in all main terminals and checks validity of registration and deregistration by contract-time personal authentication information, contents can be delivered only to reliable home networks. Also, the setting of registration limitation conditions prevents malicious contractors from illegally increasing subterminals. An accounting system dependent on the configuration of subterminals can be built.

The contents sending part 32 can deliver all contents of formats processable to a main terminal making a request for contents delivery and subterminals registered in the main terminal. For example, when a request for contents delivery is issued from a main terminal with a main terminal ID of 10023, since it is determined from the main terminal contract management table (FIG. 2) and the subterminal management table (FIG. 3) that a format supported by the main terminal is MPEG2, and formats supported by subterminals registered in the main terminal are Real Video and MPEG2, requested contents are delivered in the MPEG2 and Real Video formats. Similarly, when a request for contents delivery is issued from a main terminal with a main terminal ID of 9303, request contents are delivered in the MPEG2, MPEG4 and Real Video formats. This makes format conversion in receiving terminals unnecessary.

Only contents of formats processable to terminals permitted by contents license can be delivered. For example, when a request to deliver contents with contents ID 9303 and version 30 is issued from a main terminal with a main terminal ID of 10023, if licenses are set as shown by the contents license management table shown in FIG. 5, although a format supported by the main terminal is MPEG2 and formats supported by a subterminal registered in the main terminal are Real Video and MPEG2, since use in only the main terminal is permitted, only contents of MPEG2 format may be delivered. This prevents the delivery of meaningless contents not used because of the lack of license.

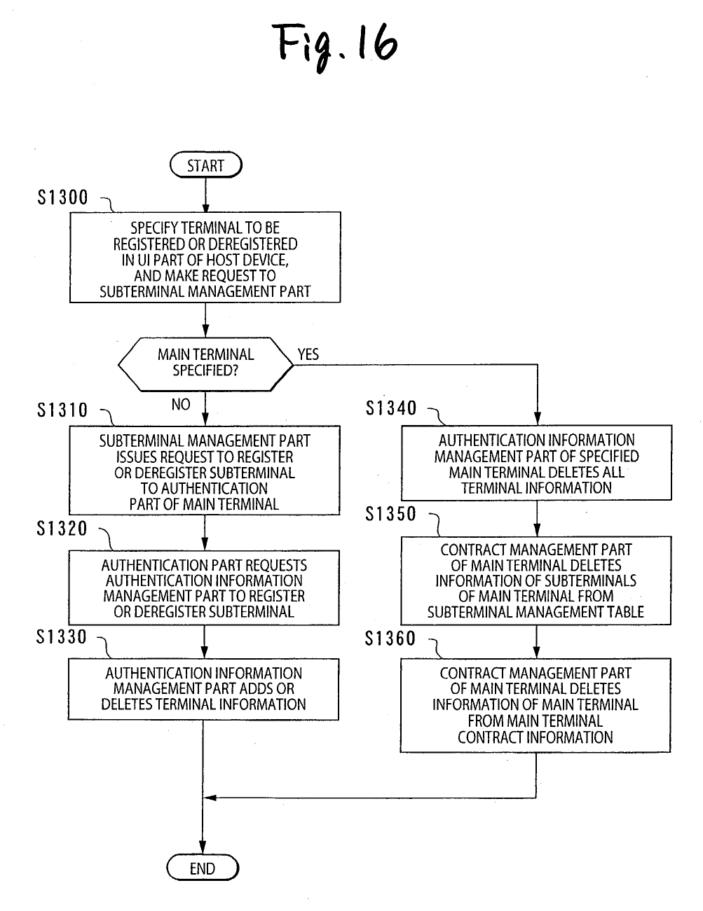

Next, an example of deregistering a main terminal and a subterminal specified in the host device 20 will be described with reference to the flowchart of FIG. 16. The UI part 37 of the host terminal 20 specifies terminals to be registered or deregistered and makes a request to the subterminal management part 35 for deregistration (S1300). The terminals are specified with terminal IDs, terminal types, and the like.

If a specified terminal is a main terminal, the subterminal management part 35 directs the main terminal to deregister all subterminals, and the authentication information management part 45 of the main terminal deregisters all subterminals (S1340). The subterminal management part 35 deletes information relating to the subterminals of the main terminal from the subterminal management table (S1350), and requests the main terminal contract management part 36 to delete information of the terminals. The main terminal contract management part 36 deletes information of the main terminal from the main terminal contract management table (S1360). The deleted main terminal will be unable to enjoy contents delivery from the host device.

If the specified terminal is a subterminal, the subterminal management part 35 issues a request to deregister the subterminal to the authentication part 43 of the main terminal 21 in which the subterminal is registered (S1310). The authentication part 43 requests the authentication information management part 45 to deregister the subterminal (S1320), and the authentication information management part 45, according to the request, deletes information of the subterminal from the subterminal management table (S1330). If a terminal type is specified for deregistration, all subterminals registered in all main terminals are scanned, and the above processing is performed for subterminals matching the specified terminal type. Although the above description has been made of deregistration, registration is performed according to the same flow as in deregistration, except that deletion processing is replaced by addition processing. In deletion processing with a main terminal specified, although all subterminals registered in the main terminal have been deregistered, if there occurs no contradiction at reregistration, the subterminals may be left intact. By thus registering and deregistering terminals specified in a host terminal, even if a problem arises in terminal security due to bugs or hacking, the problematic terminal can be quickly deregistered. If the problem has been solved as a result of bug correction, deregistered terminals can be quickly reregistered.

(Second Embodiment)

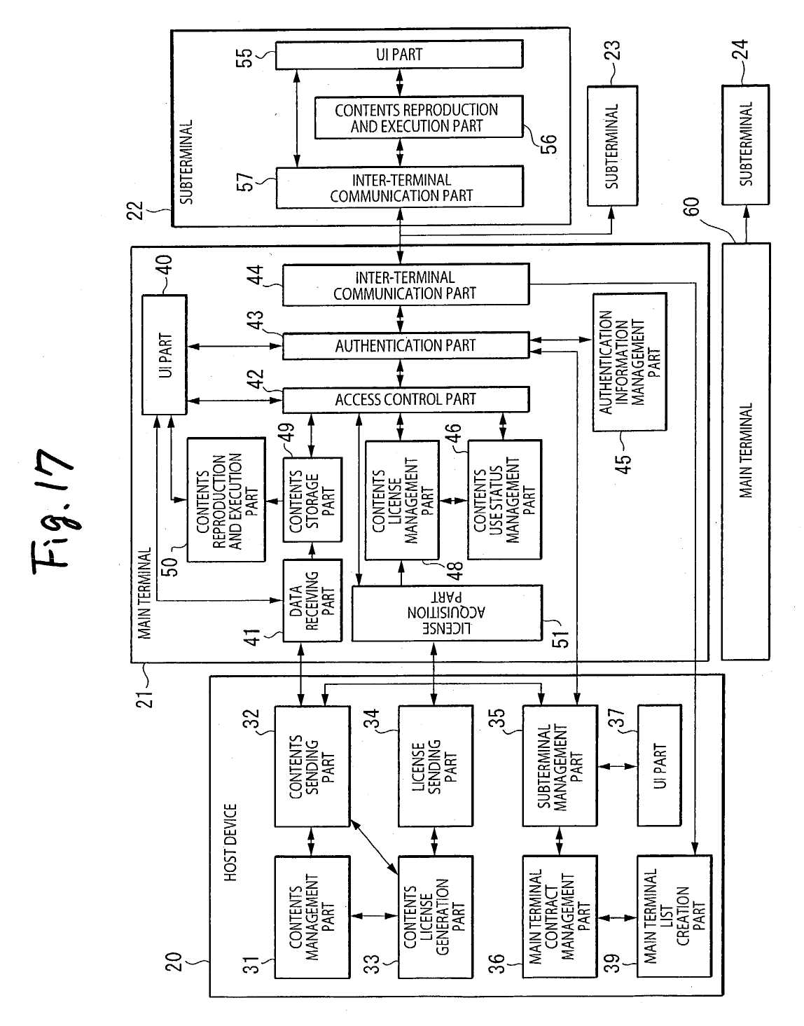

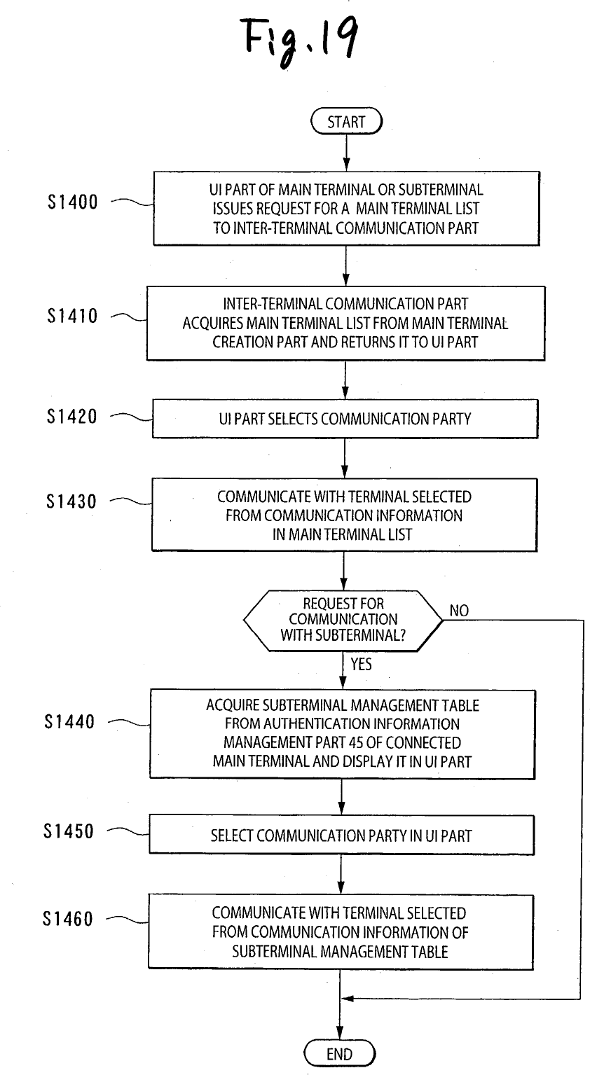

A second embodiment of the present invention will be described with reference to FIG. 17. Components in the second embodiment that are identical to components in the first embodiment are identified by the same reference numbers; descriptions of them are omitted. The second embodiment is characterized in that communication is enabled between main terminals and subterminals that receive contents delivered from the host device 20. The flow of processing of inter-terminal communication in the second embodiment of the present invention will be described with reference to a flowchart of FIG. 19.

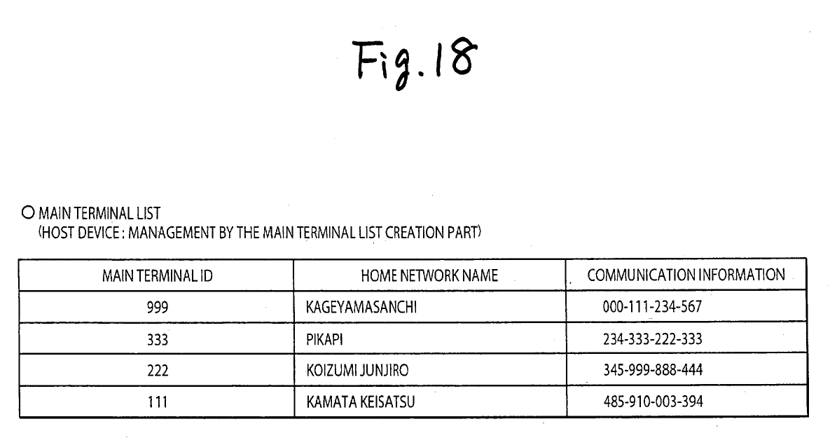

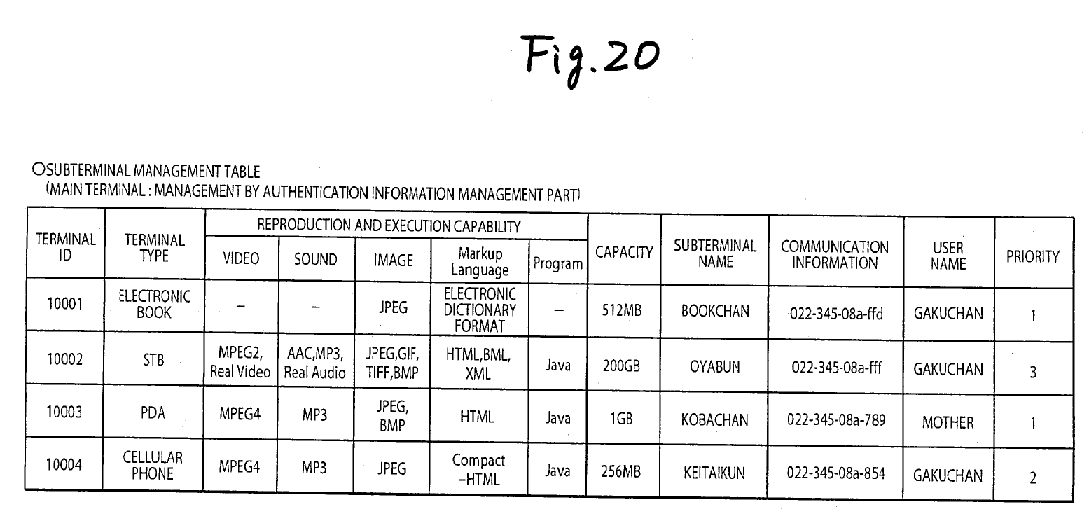

A main terminal list creation part 39 of the host device 20 in FIG. 17 creates a main terminal list from the main terminal contract management information managed by the main terminal contract management part 36. The main terminal contract management information contains main terminal IDs, home network names, and communication information for communicating with main terminals. The main terminal list, shown in FIG. 18, is used to select communication parties in main terminals and subterminals. When a main terminal (or subterminal) performs communication with terminals belonging to other home networks, the UI part 40 (UI part 55 in the case of subterminal) issues a request for the main terminal list to the inter-terminal communication part 44 (S1400). A request from the UI part 55 of a subterminal is issued through the inter-terminal communication part 57. The inter-terminal communication part 44 obtains the main terminal list from the main terminal list creation part 38 of the host device 20 and returns it to the UI part 40 (UI part 55 in the case of requests from a subterminal) (S1420). The UI part 40 (or UI part 55) displays the main terminal list and the user selects a main terminal to be connected (S1430). The inter-terminal communication part 44 (or inter-terminal communication part 57) communicates with a main terminal selected by communication information contained in the main terminal list (S1430). If communication with a subterminal is requested, the UI part 40 (or UI part 55) obtains and displays a subterminal management table, which is a list of subterminals registered in a home network including the main terminal, from the authentication information management part 45 of the connected main terminal 21 through the inter-terminal communication part 44 (S1440). The subterminal management table, as shown in FIG. 20, contains terminal IDs, terminal types, terminal names, and communication information for communicating with subterminals of interest. The user selects a subterminal from the displayed subterminal management table (S1450). The inter-terminal communication part 44 (or the inter-terminal communication part 57) communicates with a terminal selected from communication information of the subterminal management table.

In this example, connection is made to a desired main terminal of a home network, and then connection is made to a subterminal within the home network. However, alternatively, after the main terminal list creation part 39 of the host device 20 creates a list containing all subterminals within the home network from the main terminal management table and the subterminal management table respectively managed by the main terminal contract management part 36 and the subterminal management part 35, the list may be sent to a main terminal or subterminal. This enables communication with a selected subterminal without communicating with a main terminal.

When the UI part 40 (UI part 55) selects a main terminal, communication requests may be sent to the main terminal and all subterminals connected to the main terminal. In this case, communication is made with a terminal that responded earliest to the communication request. The authentication information management part 45 of the main terminal 21 beforehand may set terminals to which to send communication requests so that the communication requests are sent to one or more of the set terminals without sending the subterminal management table.

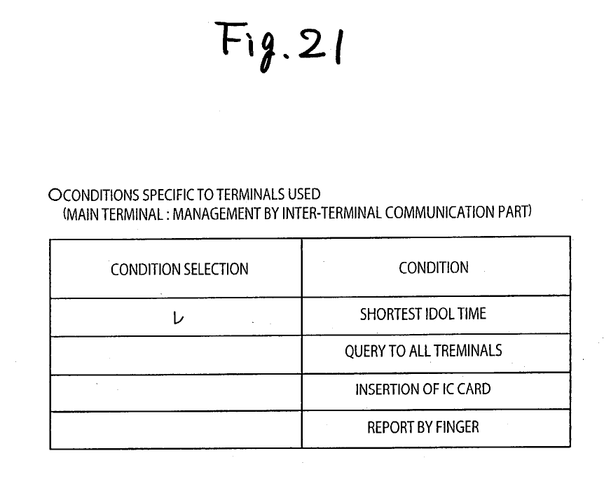

In the case where users are managed by the subterminal management table as shown in FIG. 20, users, not terminals, may be selected as communication destinations. For example, in FIG. 20, a user “Gakuchan” may be selected. In the case where the user uses plural terminals, priority may be set. If “Gakuchan” is selected, communications with terminals having higher priorities (smaller numbers) are performed earlier. If communication fails for the reason of absence or the like, communication with a terminal having the next highest priority of the same user is tried. Other information exchange methods are possible: instead of setting priorities in advance in the subterminal management table, of terminals used by the individual, communication with a terminal having the shortest idol time is tried; terminals in which an IC card for identifying an individual is inserted are preferentially selected; and a query is made to all terminals within a network and communication is made with responding terminals. These conditions specific to terminals used are set in the inter-terminal communication part 44 (see FIG. 21), which attempts communication with individuals, based on the conditions.

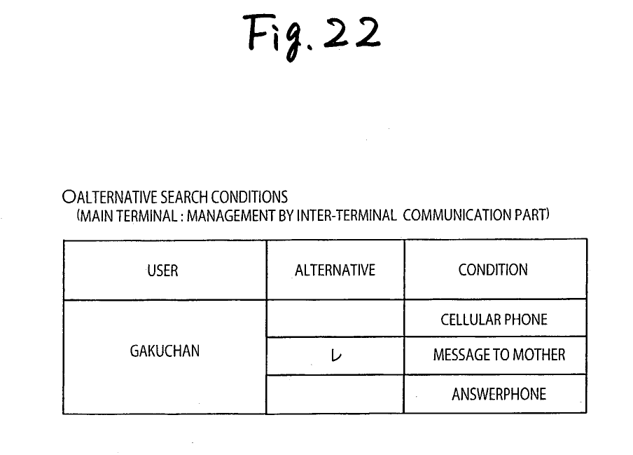

Considering the case where communication with a selected individual cannot be performed, alternative search conditions may be set in the inter-terminal communication part 44 (FIG. 22). In an example of FIG. 22, if communication with “Gakuchan” is impossible because “Message to mother” is set, connection is made with a terminal used by “mother” to pass a message. If “Cellular phone” is set, a call is issued to a phone number set in advance. If “Answerphone” is set, a message can be recorded. A mail address may be set so that mail is sent to the address.

The abstract word “communication” in the above description specifically refers to phone, file transfer by telnet and ftp, and information exchange by chat. Conditions specific to terminals used and alternative search conditions may include conditions other than those described here, depending on information exchange methods.

By thus achieving simple communication means between households holding contracts with one service provider, there can be provided services by which service providers undertaking contents delivery collect contractors.

(Third Embodiment)

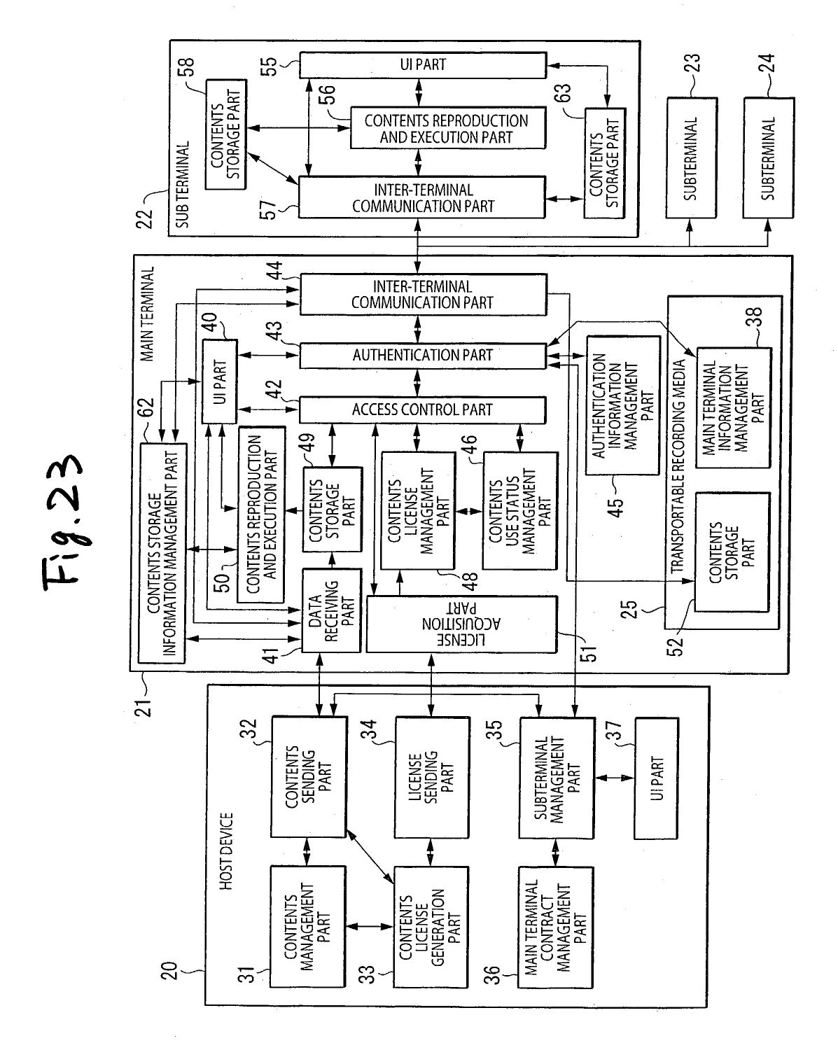

A third embodiment of the present invention will be described with reference to FIG. 23. Components in the third embodiment that are identical to components in the first embodiment or second embodiment are identified by the same reference numbers; descriptions of them are omitted. The third embodiment is characterized in that a contents storage information management part 62 manages the storage statuses of plural contents storage parts within a home network.

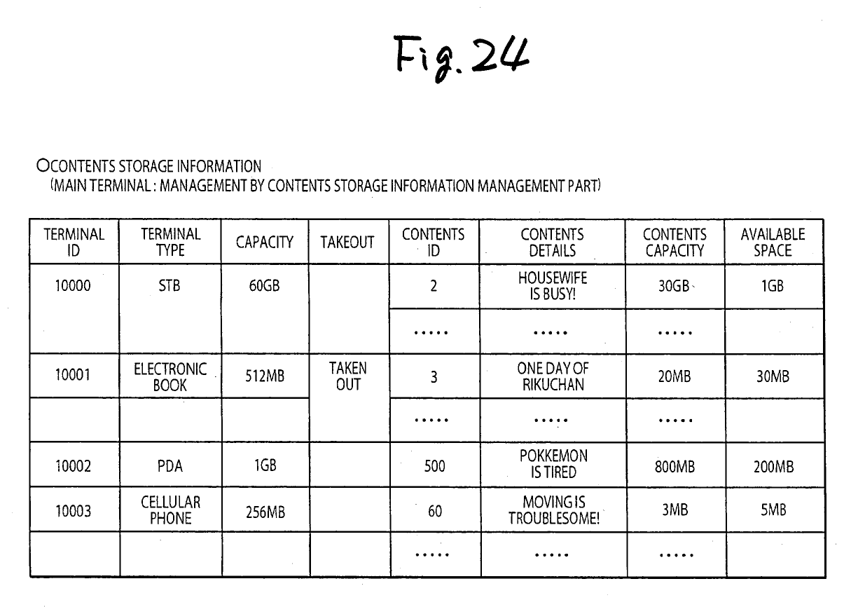

The third embodiment is the same as the first and second embodiments in that a subterminal management table containing the capacities of the respective storage devices of subterminals is managed by the authentication information management part 45. For example, a subterminal management table as shown in FIG. 20 is held in the authentication information management part 45. The contents storage information management part 62 manages a copy of information about terminal ID, terminal type, and capacity, storage states (the IDs, contents details, and contents capacities of stored contents, and available space) of individual terminals, and contents storage information about terminal takeout state (indicates whether the terminal can be accessed from within a home network). A takeout state is determined in such a way that the contents storage information management part 62 periodically checks all subterminals through the inter-terminal communication part 44. Contents storage information is as shown in FIG. 24. Terminals can include transportable recording media. Available methods for determining whether access can be made from within a home network are to determine whether connection is made by cables, and whether wireless transmission speed is equal to or greater than a reference value.

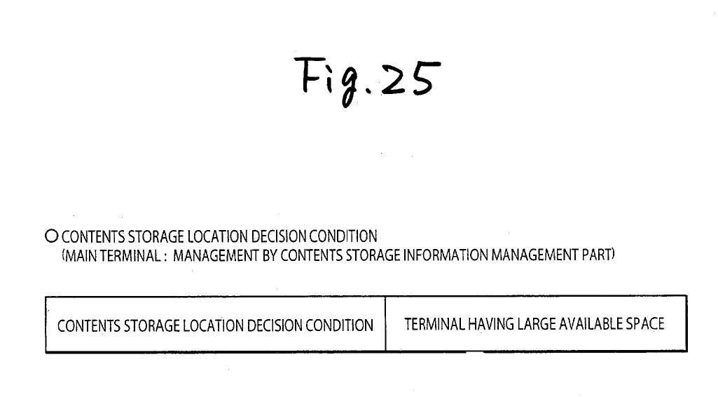

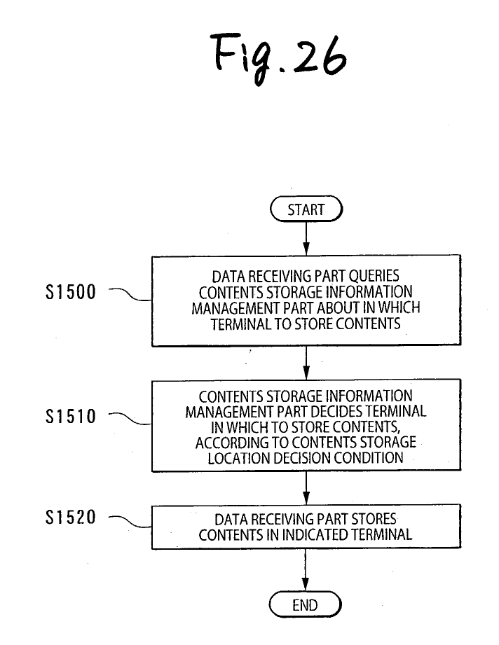

In such a configuration, referring to a flowchart of FIG. 26, a description will be made of the flow of processing of up to contents storage in the case where contents are delivered from a host terminal as shown in the first embodiment. The data receiving part 41 of the main terminal 21, upon receiving data, queries the contents storage information management part 62 as to a subterminal (including transportable recording media) in which to store contents (S1500). The contents storage information management part 62 holds contents storage location decision conditions as shown in FIG. 25 and decides a contents storage location according to the conditions (S1510). Since FIG. 25 shows that a contents storage location decision condition is a terminal having a large available space, in the case where a query is issued from the data receiving part 41, the contents storage information management part 62 refers to a contents storage management table of FIG. 24 and gives an indication to store contents in STB of ID 10000, which has the largest available space. The data receiving part 41 stores contents in the contents storage part of STB (S1520).

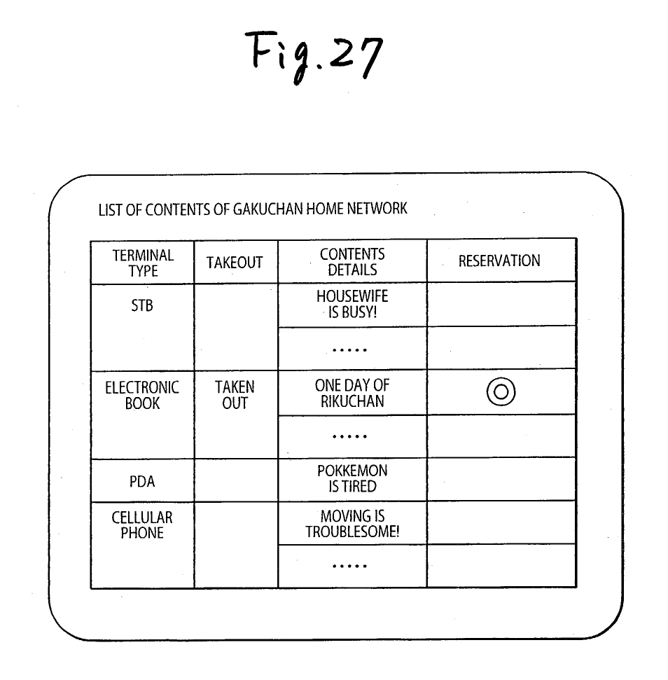

Although the flow of processing for reproducing contents is the same as that in the first embodiment, by displaying the contents management table in the UI part 40 (or UI part 55) along with contents management information held by the contents storage information management part 62, whether access can be made to contents stored in terminals within a home network can be indicated to the user. This prevents the user from reproducing inaccessible contents. An example of presentation in the UI part 40 (or UI part 55) is shown in FIG. 27. Inaccessible contents can be reserved in the contents storage management information. For example, in the presentation example of FIG. 27, since “One day of Rikuchan” is stored in an electronic book taken out, it is appreciated that the contents cannot be accessed from the current home network. In such a case, a reservation is made in the UI part 40 (or UI part 55) and reservation details (reserved contents, a reserving terminal, etc.) are managed by the contents storage information management part 62. The contents storage information management part 62, when a taking-out terminal has become accessible, checks whether reservations are made for contents of the terminal, and if so, notifies the UI part 40 (or UI part 55) of a reserving terminal that the contents have become accessible.

Although the above description has been made of the case where terminals are taken out of a home network, the following description will be made of a method for processing reproduction requests for contents stored in terminals taken out of a home network.

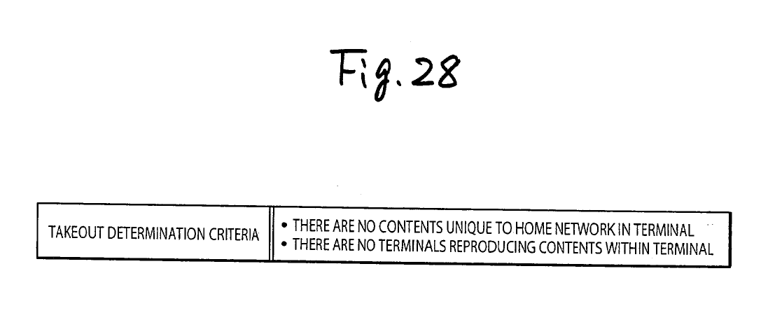

When the subterminal 22 is to be taken out of the range of access to a home network, the user queries a takeout determination part 63 about whether the subterminal can be taken out, through the UI part 40. The takeout determination part 63 queries the contents storage information management part 62 about whether the subterminal can be taken out, through the inter-terminal communication part 57 and the inter-terminal communication part 44. The contents storage information management part 62 holds a takeout determination criterion as shown in FIG. 28 and determines whether the subterminal can be taken out, according to the takeout determination criterion. Only when the takeout determination criterion can be cleared, the contents storage information management part 62 issues takeout OK. Even in the case of takeout NG, when there is a strong desire to take out the subterminal, arrangements are made so that the takeout determination criterion can be cleared. For example, in the case where “there are no contents unique to the home network in the terminal” in the takeout determination criterion of FIG. 28 cannot be cleared, that is, contents existing in only the terminal exist, the contents are copied to another terminal such as a main terminal. Thereby, users of terminals other than the terminal taken out can satisfy their desire to reproduce the contents.

As has been described above, by collectively managing storage states in plural contents storage parts within a home network and enabling takeout limitations and reservations for the contents, the states of storage devices of plural terminals within the home network can be shown in a form easily understandable to users because the storage devices appear to be one storage device.

(Fourth Embodiment)

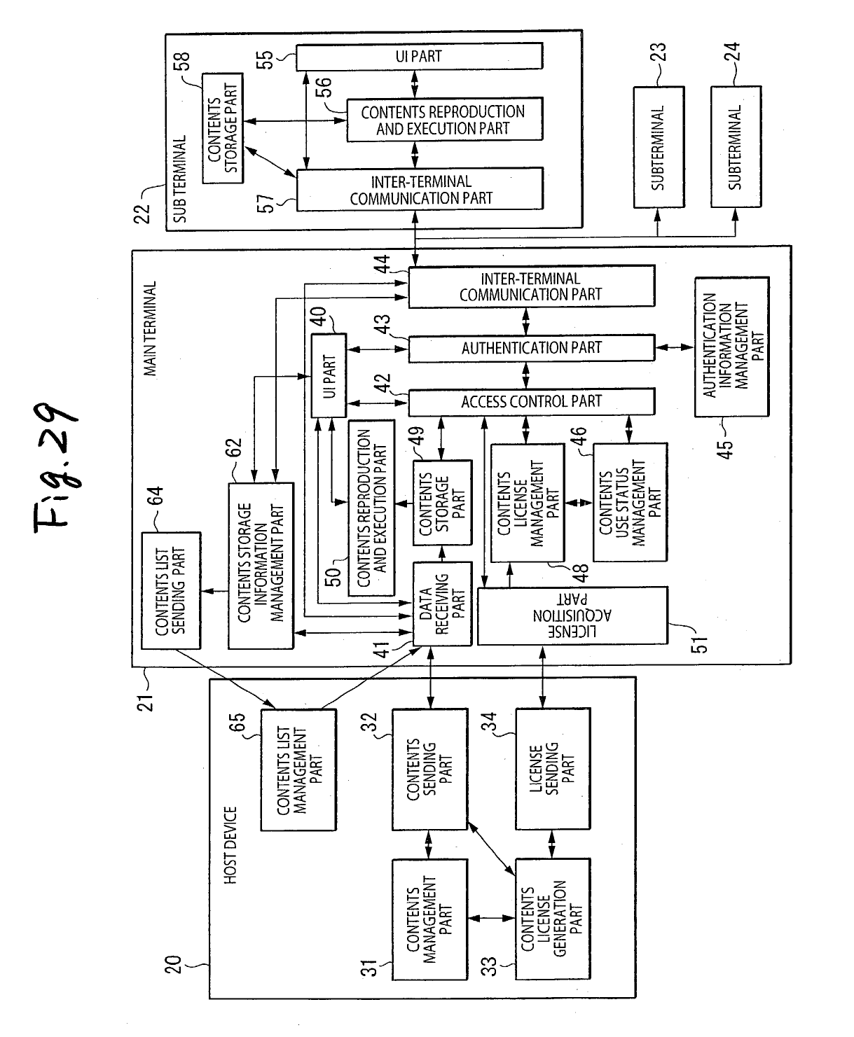

A fourth embodiment of the present invention will be described with reference to FIG. 29. Components in the fourth embodiment that are identical to components in the first to third embodiments are identified by the same reference numbers; descriptions of them are omitted. The fourth embodiment is characterized in that a list of contents successfully stored by individual home networks is delivered to all (or part) of main terminals so that contents duplication and movement from other home networks are enabled.

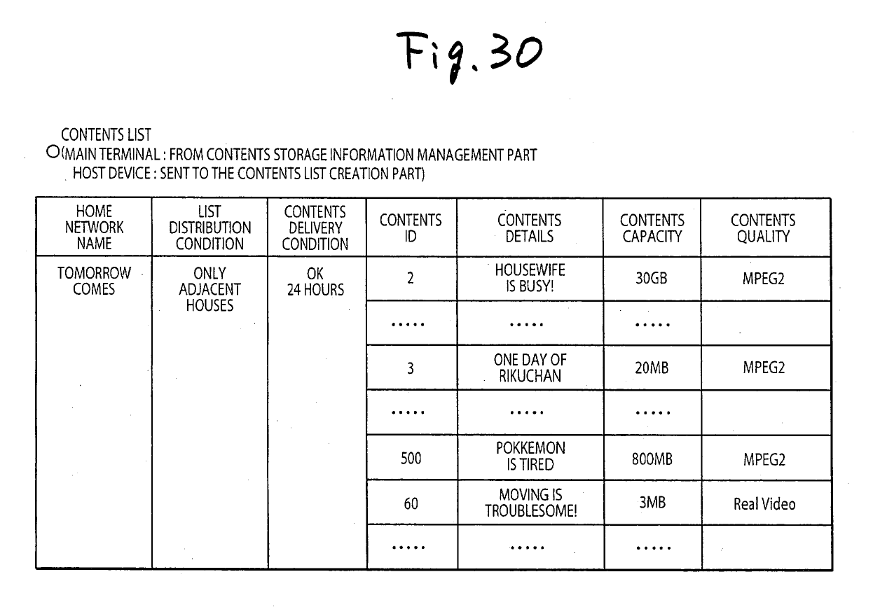

A contents list sending part 64 of the main terminal 21 creates a contents list from contents storage information managed by the contents storage information management part 62 and sends it to a contents list management part 65 of the host device 20. In this case, the contents storage information may be added with list delivery conditions, contents delivery conditions, contents quality, and the like set by individual main terminals. The list delivery conditions are delivery levels of contents storage information by which setting can be made so that a contents list may be delivered to familiar associates and is not delivered to unfamiliar people. The contents delivery conditions, which are conditions for delivering contents to other home networks, may include time conditions such as all-day run and daytime run, and conditions for limiting home networks of delivery destinations. Contents quality refers to contents format and the like for users and terminals to determine whether to receive delivery. A contents list sent from the contents list sending part 64 to a contents list management part 65 is, for example, as shown in FIG. 30. Although, in the example, list delivery conditions and contents delivery conditions are grouped by home network, they may be grouped by contents.

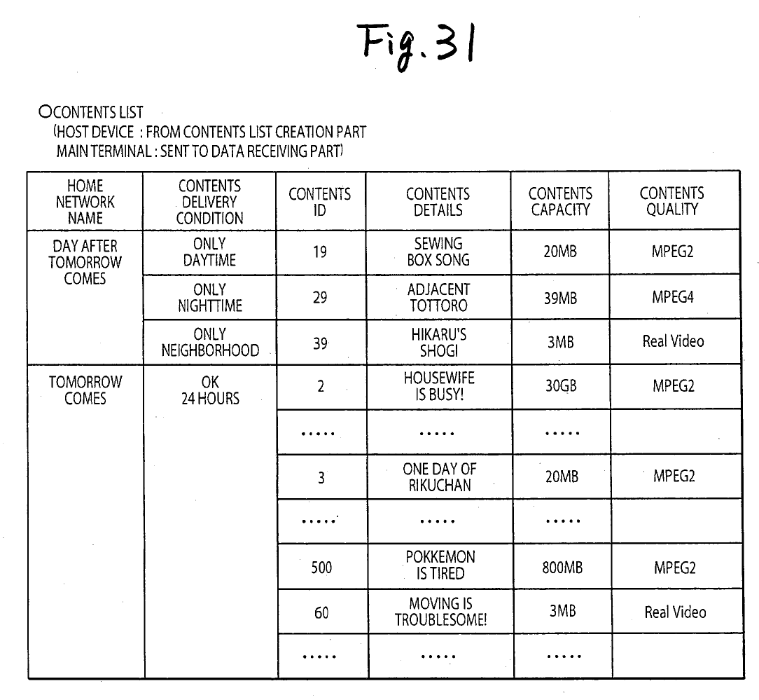

The contents list management part 65 collects contents storage information collected from plural host devices 20 and again sends it to the data receiving part 41 of all (or part) of main terminals 21. A contents list delivered is as shown in FIG. 31. FIG. 31 shows merged contents lists from plural home networks, wherein the contents lists are delivered to only home networks meeting list delivery conditions. The UI part 40 of the main terminal 21 receives and displays a contents list from the data receiving part 41 (in the case of the UI part 55 of the subterminal, through the inter-terminal communication part 57 and the inter-terminal communication part 44), and the user selects necessary contents and receives the contents from a home network storing the contents.

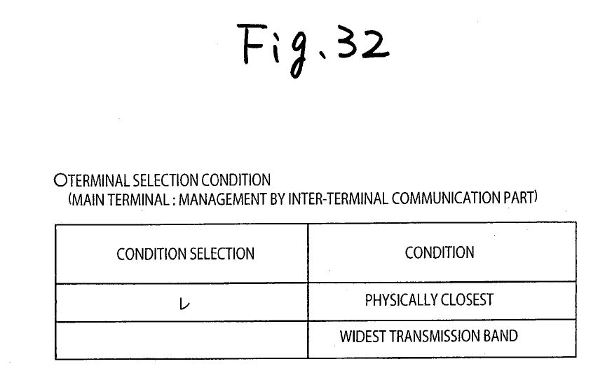

Although information exchange with other home networks is basically performed according to the method described in the second embodiment, if the same contents exist in plural home networks, home networks to receive delivery are selected according to terminal selection conditions as shown in FIG. 32 held in the inter-terminal communication part 44 (inter-terminal communication part 57).

After receiving contents, the main terminal 21 receives a contents license from the host device 20 according to the method described in the first embodiment, so that the contents can be reproduced.

Although the above description has been made of an example that the host device 20 collects and merges contents lists from the main terminal 21, if, each time contents are sent from the host device 20, it can be checked whether the contents have been successfully stored, contents lists do not need to be collected because the host device 20 can recognize storage states.

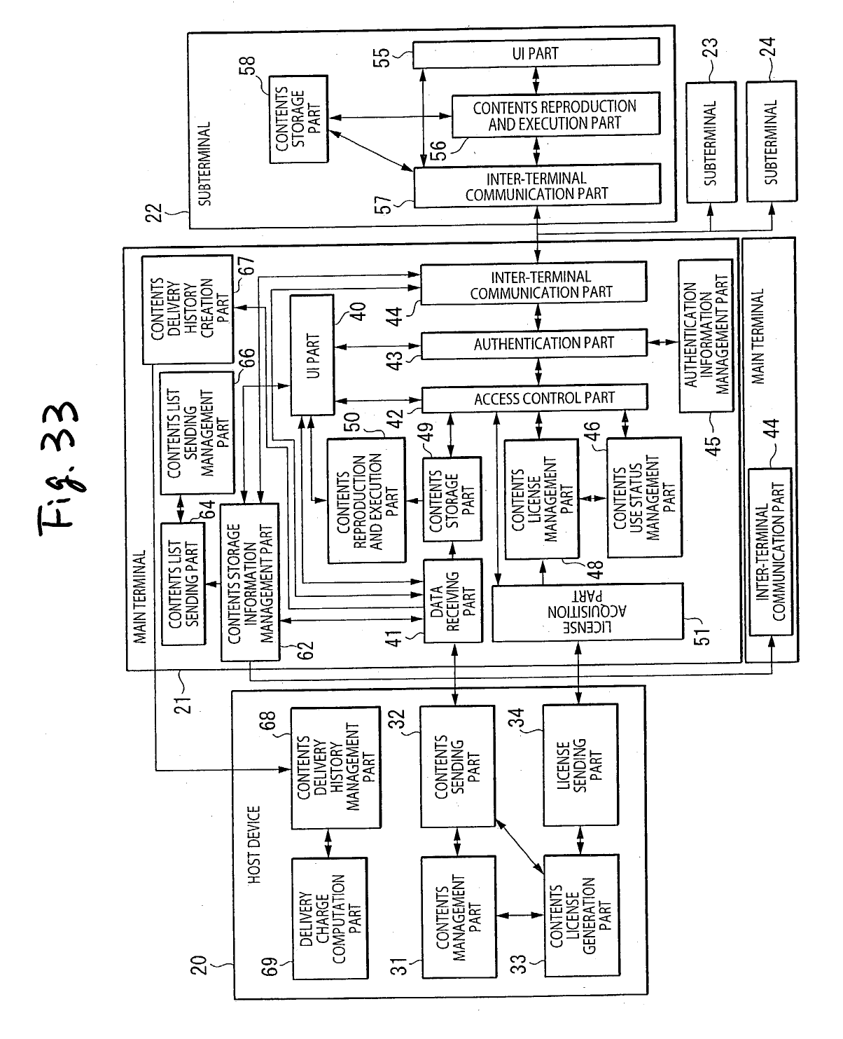

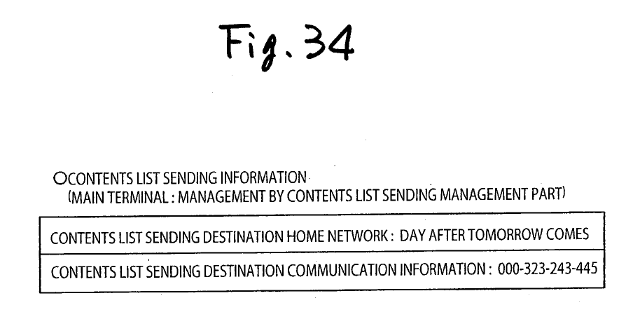

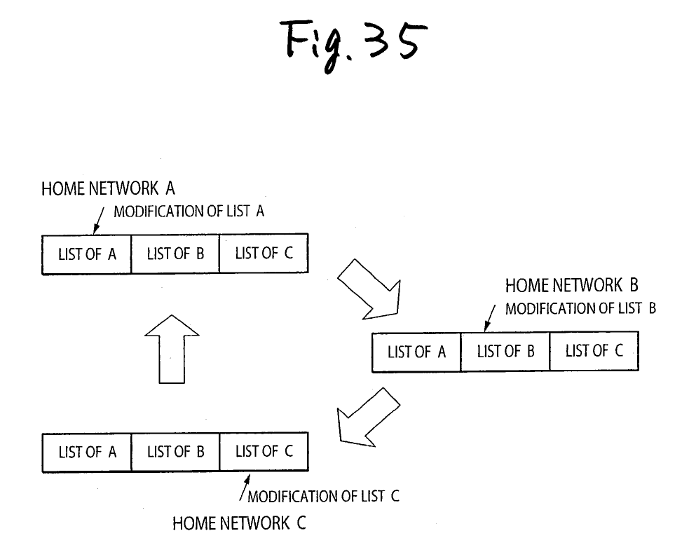

A description will be made of an example of sharing contents lists among all (or some) of home networks by circulating the contents lists among main terminals. A configuration for achieving this is shown in FIG. 33. The contents list sending management part 66 of the main terminal 21 manages contents list sending information, which is information indicating the sending destinations of contents lists created by the contents list sending part 64. An example of the contents list sending information is shown in FIG. 34. The contents list sending part 64 sends a contents list created by the to the inter-terminal communication part 44 of a main terminal 21 of a destination home network indicated by the contents list sending information. Upon receiving the contents list, the inter-terminal communication part 44 passes the contents list to the contents storage information management part 62, and passes it to the contents list sending part 64 along with contents storage management information managed by itself. The contents list sending part 64 merges the received contents list and the contents storage management information to create a contents list and sends the contents list to the inter-terminal communication part 44 of a main terminal 21 of a sending destination home network indicated by the contents list sending information. Contents list sending destination-information is set so that contents lists are transferred in a wraparound form. In a second round or later, a contents list previously added by a relevant home network itself is corrected. The circulation of contents lists is shown in FIG. 35. This enables the same contents lists as shown in FIG. 31 to be shared among home networks; selection and subsequent operations in the UI part are as described in the above description.

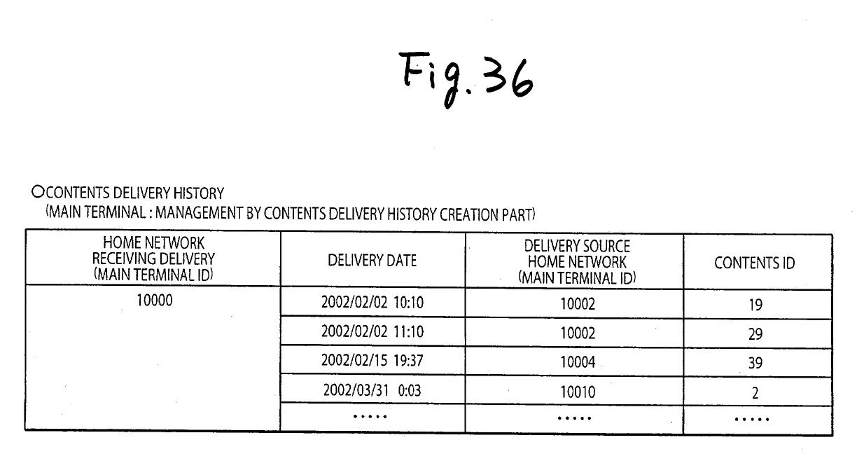

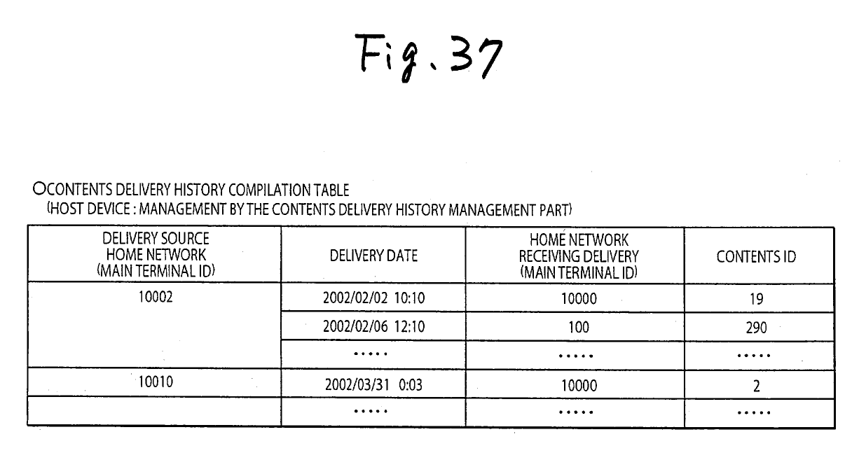

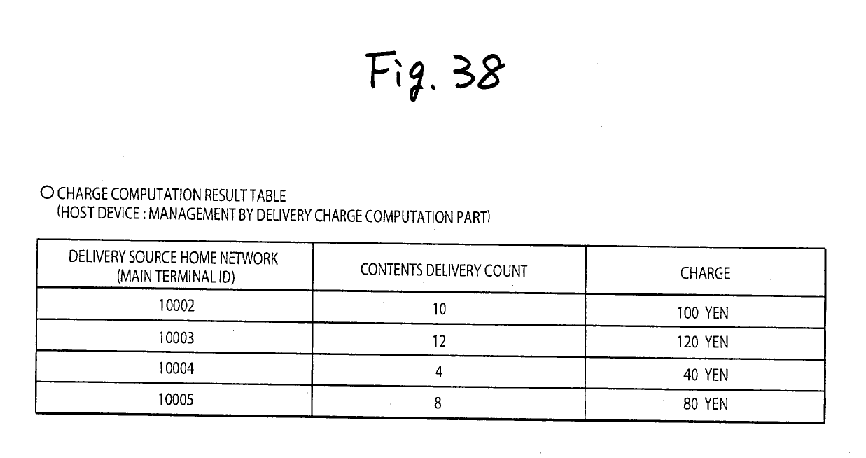

When contents are delivered from other home networks, they are created and managed as a contents delivery history in a contents delivery history creation part 67. The contents delivery history, which is, for example, as shown in FIG. 36, consists of delivery date, delivery source home network (main terminal ID), contents ID, and the like. A contents delivery history management part 68 of the host device 20 collects contents delivery histories of individual main terminals and compiles them for each of delivery source home networks. A resultant contents delivery history compilation table is, for example, as shown in FIG. 37, and shows a history of contents deliveries from individual home networks (main terminals) to other home networks. A contents delivery charge computation part 69 decides charges paid for contents delivery operations of individual home networks from the contents delivery history compilation table. Decided charges are, for example, as shown in a computation result table of FIG. 38. Although, in an example of FIG. 38, charges are determined as 10 yen per contents delivery, charges may be decided for the total of sizes of delivered contents. Charge computations for contents delivery operations by the contents delivery history creation part 67, the contents delivery history management part 68, and the contents delivery charge computation part 69 are also applicable to the contents delivery system of FIG. 29.

By thus offering contents lists to subterminals and enabling contents deliveries from other home networks, even contents having been delivered from the host device can be provided to users. Also, by compiling contents delivery histories and enabling charge computations according to the delivery histories, a business is established in which service providers managing contents and licenses and performing contents delivery pay charges for contents delivery operations to contractors of main terminals having performed contents delivery in place of the host device.

Although the present invention has been described based on preferred embodiments shown in the drawings, it is apparent that those skilled in the art may easily change and modify the invention, and such modifications are also included within the scope of the invention.

What is claimed is:

1. A contents delivery system which sends and receives contents through transmission lines, comprising:
a host device for delivering said contents;
main terminals for receiving said contents; and
subterminals for using contents sent from said main terminals, wherein
said host device includes a subterminal management part for managing information about subterminals for using contents sent from said main terminal; and
said main terminals include an authentication part for registering or deregistering subterminals permitted to use contents sent from the main terminals after querying the subterminal management part of said host device about whether to permit the registration or deregistration.

2. The contents delivery system according to claim 1, wherein
said host device further includes a main terminal contract management part for managing personal information about contracts of the main terminals;
the authentication part of said main terminals, when querying the subterminal management part of said host device about whether to permit the registration or deregistration, for sending personal authentication information about contractors of the main terminals together; and
said subterminal management part compares personal information managed by said main terminal contract management part and sent personal authentication information to determine whether to permit the registration or deregistration.

3. The contents delivery system according to claim 1, wherein
said main terminals or subterminals can mount and dismount a transportable recording medium; and
said transportable recording medium further includes a main terminal information management part for managing information about a main terminal in which the medium is recorded.

4. The contents delivery system according to claim 1, wherein, when a query about whether to permit registration or deregistration is made to the subterminal management part of said host device, said subterminal management part determines whether to permit the registration or deregistration according to a registration limitation condition.

5. The contents delivery system according to claim 4, wherein said registration limitation condition is a number of registrable subterminals.

6. The contents delivery system according to claim 5, wherein said number of registrable subterminals can be set for each of main terminals.

7. A contents delivery system sending and receiving contents through transmission lines, comprising:
a host device for delivering said contents;
main terminals for receiving said contents; and
subterminals for using contents sent from said main terminals, wherein
said host device includes a subterminal management part for managing information about subterminals for using contents sent from said main terminals, and further a UI part for specifying a subterminal to be registered or deregistered; and
said subterminal management part indicates the registration or deregistration of a subterminal specified from the UI part to the authentication part of a main terminal in which the subterminal is registered.

8. A contents delivery system sending and receiving contents through transmission lines, comprising:
a host device for delivering said contents;
main terminals for receiving said contents; and
subterminals for using contents sent from said main terminals, wherein
said host device includes a subterminal management part for managing information about subterminals for using contents sent from said main terminals, and a UI part for specifying a main terminal to be registered or deregistered; and
said subterminal management part indicates the registration or deregistration of a subterminal to an authentication part of a main terminal specified from the UI part, and deletes information about the subterminal.

9. A contents delivery system sending and receiving contents through transmission lines, comprising:
a host device for delivering said contents;
main terminals for receiving said contents; and
subterminals for using contents sent from said main terminals, wherein
said host device includes: a subterminal management part for managing format information of contents processable to subterminals for using contents sent from said main terminals; a contents management part for managing contents sent to the main terminals; and a contents sending part for sending contents to the main terminals; and
contents sent from the host device to main terminals have formats processable to the main terminals or subterminals for using contents sent from the main terminals.

10. The contents delivery system according to claim 9, wherein:
the host device further includes a contents license generation part for managing contents licenses and generating contents license information that defines contents use conditions; and
when contents are sent to said main terminals, of the main terminals or subterminals for using contents sent from the main terminals, only contents having formats processable to the main terminals or subterminals for using contents sent from said main terminals are sent to the main terminals, wherein the main terminals and subterminals are permitted to use the contents in said contents use conditions.

11. The contents delivery system according to claim 1, wherein
said host device further includes a main terminal list creation part for creating a list of main terminals or subterminals;
said main terminals or subterminals further include a UI part for enabling specification of other main terminals or subterminals registered in the main terminals as communication parties, and an inter-terminal communication part for communicating with other terminals; and
when a communication party is selected in the UI part from a list of main terminals or subterminals created by the main terminal list creation part, the inter-terminal communication part communicates with the elected communication party.

12. The contents delivery system according to claim 7, wherein
said host device further includes a main terminal list creation part for creating a list of main terminals or subterminals;
said main terminals or subterminals further include a UI part for enabling specification of other main terminals or subterminals registered in the main terminals as communication parties, and an inter-terminal communication part for communicating with other terminals; and
when a communication party is selected in the UI part from a list of main terminals or subterminals created by the main terminal list creation part, the inter-terminal communication part communicates with the elected communication party.

13. The contents delivery system according to claim 8, wherein
said host device further includes a main terminal list creation part for creating a list of main terminals or subterminals;
said main terminals or subterminals further include a UI part for enabling specification of other main terminals or subterminals registered in the main terminals as communication parties, and an inter-terminal communication part for communicating with other terminals; and
when a communication party is selected in the UI part from a list of main terminals or subterminals created by the main terminal list creation part, the inter-terminal communication part communicates with the elected communication party.

14. The contents delivery system according to claim 9, wherein
said host device further includes a main terminal list creation part for creating a list of main terminals or subterminals;
said main terminals or subterminals further include a UI part for enabling specification of other main terminals or subterminals registered in the main terminals as communication parties, and an inter-terminal communication part for communicating with other terminals; and
when a communication party is selected in the UI part from a list of main terminals or subterminals created by the main terminal list creation part, the inter-terminal communication part communicates with the elected communication party.

15. The contents delivery system according to claim 11, wherein, when other main terminals are selected in the UI part of said main terminals or subterminals, communication requests are issued to the selected main terminals or all or some of subterminals registered in the main terminals.

16. The contents delivery system according to claim 1, wherein
said host device further includes a main terminal list creation part for creating a list of main terminals;
said main terminals further include an authentication information management part for managing a list of subterminals registered in themselves;
said main terminals or subterminals further include a UI part for enabling specification of communication parties, and an inter-terminal communication part for communicating with other terminals;
main terminals are selected from said list of main terminals in the UI part;
the inter-terminal communication part communicates with the selected main terminals to receive a list of subterminals created by the authentication information management part of the main terminals; and
subterminals to serve as communication parties are selected from the list of subterminals in the UI part, and the inter-terminal communication part communicates with the subterminals.

17. The contents delivery system according to claim 7, wherein
said host device further includes a main terminal list creation part for creating a list of main terminals;
said main terminals further include an authentication information management part for managing a list of subterminals registered in themselves;
said main terminals or subterminals further include a UI part for enabling specification of communication parties, and an inter-terminal communication part for communicating with other terminals;
main terminals are selected from said list of main terminals in the UI part;
the inter-terminal communication part communicates with the selected main terminals to receive a list of subterminals created by the authentication information management part of the main terminals; and
subterminals to serve as communication parties are selected from the list of subterminals in the UI part, and the inter-terminal communication part communicates with the subterminals.

18. The contents delivery system according to claim 8, wherein
said host device further includes a main terminal list creation part for creating a list of main terminals;
said main terminals further include an authentication information management part for managing a list of subterminals registered in themselves;
said main terminals or subterminals further include a UI part for enabling specification of communication parties, and an inter-terminal communication part for communicating with other terminals;
main terminals are selected from said list of main terminals in the UI part;
the inter-terminal communication part communicates with the selected main terminals to receive a list of subterminals created by the authentication information management part of the main terminals; and
subterminals to serve as communication parties are selected from the list of subterminals in the UI part, and the inter-terminal communication part communicates with the subterminals.

19. The contents delivery system according to claim 9, wherein:
said host device further includes a main terminal list creation part for creating a list of main terminals;
said main terminals further include an authentication information management part for managing a list of subterminals registered in themselves;
said main terminals or subterminals further include a UI part for enabling specification of communication parties, and an inter-terminal communication part for communicating with other terminals;
main terminals are selected from said list of main terminals in the UI part;
the inter-terminal communication part communicates with the selected main terminals to receive a list of subterminals created by the authentication information management part of the main terminals; and
subterminals to serve as communication parties are selected from the list of subterminals in the UI part, and the inter-terminal communication part communicates with the subterminals.

20. The contents delivery system according to claim 11, wherein said list of main terminals or subterminals contains information (personal information) about individuals using the terminals, and selection by the personal information is enabled.

21. The contents delivery system according to claim 16, wherein said list of main terminals or subterminals contains information (personal information) about individuals using the terminals, and selection by the personal information is enabled.

22. The contents delivery system according to claim 20, wherein, when a selected individual holds plural terminals, the inter-terminal communication part determines terminals to be used by conditions specific to the terminals used.

23. The contents delivery system according to claim 21, wherein, when a selected individual holds plural terminals, the inter-terminal communication part determines terminals to be used by conditions specific to the terminals used.

24. The contents delivery system according to claim 11, wherein, when communication with a terminal selected as a communication party is disabled or a selected individual is absent, said inter-terminal communication part selects an alternative terminal or individual by alternative search conditions to communicate with the selected terminal or a terminal owned by the selected individual.

25. The contents delivery system according to claim 16, wherein, when communication with a terminal selected as a communication party is disabled or a selected individual is absent, said inter-terminal communication part selects an alternative terminal or individual by alternative search conditions to communicate with the selected terminal or a terminal owned by the selected individual.

26. A contents delivery system sending and receiving contents through transmission lines, comprising:
a host device for sending said contents;
main terminals for receiving said contents; and
subterminals for using contents sent from said main terminals, wherein
said subterminals include a contents storage part for storing contents sent from said main terminals;
said main terminals include a contents storage part for storing contents sent from said host terminal, and a contents storage information management part for managing contents storage information; and
the contents storage information management part determines locations for storing contents sent from the host device according to the contents storage information.

27. The contents delivery system according to claim 26, wherein said contents storage information indicates a state of available space of said contents storage part.

28. The contents delivery system according to claim 26, wherein
said main terminals or subterminals further include a UI part for showing contents storage information;
said contents storage information contains a list of contents stored in contents storage parts of main terminals and subterminals registered in the main terminals, and information about whether subterminals are taken out; and
said UI part adds reproduction OK/NG information to the list of the contents and shows it.

29. The contents delivery system according to claim 26, further including a takeout determination part for determining whether said subterminals can be taken out, wherein said takeout determination part determines whether said subterminals can be taken out by contents storage information managed by said contents storage information management part and a takeout determination criterion.

30. The contents delivery system according to claim 29, wherein said takeout determination criterion is whether contents stored by only said subterminals exist.

31. The contents delivery system according to claim 29, wherein said takeout determination criterion is whether said subterminals store contents being reproduced in other terminals.

32. The contents delivery system according to claim 30, wherein, when it is determined that said subterminals cannot be taken out as a result of determination by the takeout determination criterion because contents stored by only said subterminals exist, the causative contents are copied or moved from the contents storage part of said subterminals to the contents storage part of said main terminals, or to contents storage part of other subterminals.

33. The contents delivery system according to claim 28, wherein a contents reproduction reservation indicated from said UI part is managed as a reservation state by said contents storage information management part, and the fact that the contents have become reproducible is indicated by said UI part.

34. A contents delivery system sending and receiving contents through transmission lines, comprising:
a host device for sending said contents;
main terminals for receiving said contents; and
subterminals for using contents sent from said main terminals, wherein
said host device includes a contents list management part for managing contents lists showing a correspondence between said main terminals and contents successfully stored by the individual main terminals, and sending the contents lists to said main terminals;
said main terminals include: a data receiving part for receiving a contents list sent from said contents list management part; an inter-terminal communication part for receiving contents sent from other main terminals; a UI part for showing a contents list to receive selection of contents; and a contents storage part for storing contents; and
contents selected from the UI part are received from a main terminal that successfully stored the contents.

35. The contents delivery system according to claim 34, wherein said main terminals include a contents list sending part for creating a list of contents stored in their contents storage part and in contents storage parts of subterminals registered in the main terminals and sending the list of contents to said host terminals.

36. The contents delivery system according to claim 35, wherein said contents list sending part adds a contents deliverable condition when creating a contents list.

37. The contents delivery system according to claim 36, wherein said deliverable condition is a deliverable time zone.

38. The contents delivery system according to claim 35, wherein said contents list sending part adds a contents list disclosure condition when creating a contents list.

39. The contents delivery system according to claim 35, wherein said contents list sending part adds information about contents quality when creating a contents list.

40. The contents delivery system according to claim 34, wherein, when plural main terminals successfully stored contents selected in said UI part, said inter-terminal communication part selects main terminals to deliver contents from according to terminal selection conditions.

41. The contents delivery system according to claim 34, wherein
said host device further includes a license generation part for generating license information defining contents use conditions;
said main terminals further include a license management part for managing said license information received from said host device; and
when said main terminals receive contents from other main terminals, said host device creates license information corresponding to the contents and sends the license information to the main terminals.

42. The contents delivery system according to claim 34, wherein:
said main terminals further include a contents delivery history creation part for creating contents delivery histories containing information about main terminals to deliver contents from and sending the contents delivery histories to the host device; and
said host device further include a contents delivery history management part for collecting and managing said contents delivery histories, and a delivery charge computation part for computing amounts to be paid to users of the main terminals according to the contents delivery histories.

43. A contents delivery system comprising a host device for sending contents, and receiving terminals for receiving said contents, which sends and receives data through transmission lines, wherein:
the host device of said contents delivery system includes a contents license generation part for generating and managing contents license information indicating a range of contents availability in the receiving terminals receiving data from said host device; and
said receiving terminals include an access control part for using said contents license information received from said host device to determine a range of contents availability, and a UI part for providing contents-based services by determination results of said access control part.

44. The contents delivery system according to claim 43, wherein said contents license information contains terminal limitation data capable of limiting usable terminals as a use condition.

45. The contents delivery system according to claim 43, wherein said contents license information contains use count limitation data capable of limiting a number of uses of contents as a use condition.

46. The contents delivery system according to claim 43, wherein said contents license information contains use expiration limitation data capable of limiting contents use expiration as a use condition.

47. The contents delivery system according to claim 43, wherein said receiving terminals include an authentication part for determining whether to permit connection of subterminals that can provide contents-based services by connecting to said receiving terminals.

48. The contents delivery system according to claim 47, wherein said receiving terminals include an authentication information management part for creating and managing connection limitation data when said subterminals connect to said receiving terminals.

49. The contents delivery system according to claim 48, wherein said connection limitation data contains contractor personal data, and whether to permit the connection of said subterminals is determined using said contractor personal data.

50. The contents delivery system according to claim 47, wherein said subterminals include a contents storage part for receiving, storing, and managing contents from said receiving terminals, and said receiving terminals include a contents storage information management part for managing storage statuses of contents stored in said receiving terminals and subterminals.

51. The contents delivery system according to claim 47, wherein said receiving terminals include a contents use status management part for managing use statuses of contents used in said receiving terminals and subterminals.

52. The contents delivery system according to claim 43, wherein said receiving terminals can move contents from other receiving terminals receiving services of said contents delivery system in other home networks by use of said contents license information.

53. A contents delivery system comprising a host device for sending contents, and receiving terminals for receiving said contents, which sends and receives data through transmission lines,
wherein the host device of said contents delivery system includes a contents license generation part for generating and managing contents license information indicating a range of contents availability in the receiving terminals receiving data from said data sending part.

54. A contents delivery system comprising a host device for sending contents, and receiving terminals for receiving said contents, which sends and receives data through transmission lines,
wherein the receiving terminals of said contents delivery system include an access control part for using contents license information indicating a range of availability of contents received from the host device sending data to said receiving terminals to determine a contents availability range, and a UI part for providing contents-based services by determination results of said access control part.

55. A contents delivery method for sending and receiving data between a host device for sending contents and receiving terminals for receiving said contents through transmission lines, the contents delivery method including the steps of:
in the host device sending data, creating and managing contents license information indicating a range of contents availability in the receiving terminals receiving data;
in said receiving terminals, using said contents license information received from said host device to determine a range of contents availability; and
providing contents-based services by determination results of said contents license information.

56. Recording media recording a contents delivery program for sending and receiving data through transmission lines, the contents delivery program including the steps of:
in a host device sending data, creating and managing contents license information indicating a range of contents availability in receiving terminals receiving data;
in said receiving terminals, using said contents license information received from said host device to determine a range of contents availability; and
providing contents-based services by determination results of said contents license information.

57. A contents delivery program for sending and receiving data through transmission lines, the contents delivery program instructing a computer to execute the steps of:
in a host device sending data, creating and managing contents license information indicating a range of contents availability in receiving terminals receiving data;
in said receiving terminals, using said contents license information received from said host device to determine a range of contents availability; and
providing contents-based services by determination results of said contents license information.

58. A contents delivery method for sending and receiving data through transmission lines, including the step of, in a host device sending data, creating and managing contents license information indicating a range of contents availability in receiving terminals receiving data.

59. Recording media recording a contents delivery program for sending and receiving data through transmission lines, the contents delivery program including the step of, in a host device sending data, creating and managing contents license information indicating a range of contents availability in receiving terminals receiving data.

60. A contents delivery program for sending and receiving data through transmission lines, the contents delivery program instructing a computer to execute the step of, in a host device sending data, creating and managing contents license information indicating a range of contents availability in receiving terminals receiving data.

61. A contents delivery method for sending and receiving data through transmission lines, the contents delivery method including the steps of: in receiving terminals receiving data, using contents license information indicating a range of availability of received contents to determine a range of contents availability, and providing contents-based services by determination results of said contents license information.

62. Recording media recording a contents delivery program for sending and receiving data through transmission lines, the contents delivery method including the steps of: in receiving terminals receiving data, using contents license information indicating a range of availability of received contents to determine a range of contents availability, and providing contents-based services by determination results of said contents license information.

63. A contents delivery program for sending and receiving data through transmission lines, the contents delivery program instructing a computer to execute the steps of, in receiving terminals receiving data, using contents license information indicating a range of availability of received contents to determine a range of contents availability, and providing contents-based services by determination results of said contents license information.
